(19) United States
(12) Patent Application Publication
(10) Pub. No.: US 2012/0059691 A1
(43) Pub. Date: Mar. 8, 2012

(54) Electronic Sales Incentive Distribution and Clearinghouse System

(76) Inventors: Sonny Miles, Hanover, MN (US); Eric Christopher Carr, Brooklyn Park, MN (US); Tricha Mae Miles, Hanover, MN (US)

(21) Appl. No.: 12/876,601

(22) Filed: Sep. 7, 2010

(51) Int. Cl. G06Q 30/00

(52) U.S. Cl. 705/14.1

(57) ABSTRACT

An electronic sales incentive distribution and clearinghouse system and methods of use are disclosed. One such system includes a computing system configured to receive an identification of one or more items from a customer, and, for each of the one or more items, compare the identification of the item to keywords associated with one or more product incentives to locate an incentive relating to the item; and if a keyword associated with an incentive relates to the item, prompt the customer to review and accept the incentive. The computing system is further configured to provide to the customer a shopping list of items including the item and one or more incentives including the incentive.

### TECHNICAL FIELD

The present application relates generally to distribution of sales incentives. In particular, the present application relates to an electronic sales incentive distribution clearinghouse system.

### BACKGROUND

Manufacturers and retailers of products sold in large volumes, such as food and other dispensable household goods, often promote these products by printing advertisements including coupons relating to those products. These coupons and advertisements are typically mailed or otherwise sent to potential customers who may choose to use those coupons to receive discounts on the items in any of a variety of supermarkets or other retailers.

When a customer chooses to use a manufacturer-issued coupon, that customer selects and brings those coupons to a store of the customer's choice. The customer purchases the goods that correspond to the coupons, and receives a cash discount relating to the final purchase price of the goods from the retailer. The retailer then receives reimbursement from the manufacturer based on the number of coupons that were issued by the manufacturer and used/honored by the retailer.

Retailers may also choose to print and distribute coupons related to the products and services that they have in stock. In these situations, the customer again selects the appropriate coupons, and brings them to the retailer's place of business. When the customer purchases items relating to the coupons, that customer again receives a cash discount on the final price of the goods. In this case, the cost of the discount is placed on the retailer.

Currently, a number of incentive distribution systems exist which allow electronic distribution of incentives to customers. For example, existing systems can send email messages to users that include a coupon, or provide a link to a coupon that the customer can access and print if desired. Some of these incentive distributions allow a retailer or manufacturer to control distribution of incentives, to prevent reuse of incentives. However, existing systems are typically centralized around the incentives offered to the customer, rather than prompting a customer to review and accept incentives based on customer-identified products. Consequently, those systems do not integrate well with customers' shopping lists. Those other incentive distribution systems lack historical information or statistics available to those customers regarding the incentives that customer has previously used. Additionally, existing systems do not provide a comprehensive view of savings provided by the incentives.

For these and other reasons, improvements are desirable.

### SUMMARY

In accordance with the following disclosure, the above and other problems are addressed by the following:

In a first aspect, an electronic sales incentive distribution and clearinghouse system is disclosed. The system includes a computing system communicatively connected to a network, the computing system including a memory configured to store incentive data. The computing system is configured to receive an identification of one or more items from a customer, and, for each of the one or more items, compare the identification of the item to keywords associated with one or more product incentives to locate an incentive relating to the item and, if a keyword associated with an incentive relates to the item, prompt the customer to review and accept the incentive. The computing system is further configured to provide a shopping list of items, and one or more incentives.

In a second aspect, a method of providing electronic sales incentives to a prospective customer is disclosed. The method includes receiving at an electronic sales incentive distribution and clearinghouse system a shopping list of one or more products to be purchased by a customer, the shopping list including one or more items. The method further includes comparing each of the items to keywords associated with one or more product incentives to locate an incentive relating to one or more of the items on the shopping list. The method also includes displaying the incentive to the customer, and, upon selection of the incentive, providing the incentive to the customer.

In a third aspect, a method of managing electronic sales incentives is disclosed. The method includes generating a user interface at an electronic sales incentive distribution and clearinghouse system for display to a user associated with an incentive provider, and receiving at the electronic sales incentive distribution and clearinghouse system a definition of one or more incentives associated with one or more items. The method further includes receiving third party information relating to an item from among the one or more items, and associating the third party information with the item.

In a fourth aspect, an electronic sales incentive distribution and clearinghouse system is disclosed. The system includes a computing system communicatively connected to a network, the computing system including a memory configured to store incentive data. The computing system is configured to generate a user interface at an electronic sales incentive distribution and clearinghouse system for display to a user associated with an incentive provider, and receive at the electronic sales incentive distribution and clearinghouse system a definition of one or more incentives associated with one or more items, the definition including one or more keywords associated with the one or more incentives. The computing system is further configured to receive information regarding third party information relating to an item from among the one or more items and associate the third party information with the item. The system is further configured to receive from a customer an identification of one or more items. For each of the one or more items, the system is configured to compare the identification of the item to keywords associated with one or more product incentives to locate an incentive relating to the item, and if a keyword associated with an incentive relates to the item, prompt the customer to review and accept the incentive. The system is also configured to provide to the customer a shopping list of items including the item and one or more incentives including the incentive.

### BRIEF DESCRIPTION OF THE DRAWINGS

FIG. 1 is a logical diagram of an electronic sales incentive distribution network in which aspects of the present disclosure can be implemented;

FIG. 2 is a logical diagram of an electronic sales incentive distribution and clearinghouse system, according to a possible embodiment of the present disclosure;

FIG. 3 is a block diagram illustrating example physical components of an electronic computing device useable to implement the various methods and systems described herein;

FIG. 4 is a flowchart of methods and systems for managing electronic sales incentives, according to a possible embodiment of the present disclosure;

FIG. 5 is a flowchart of methods and systems for building a shopping list while including available sales incentives managed by an electronic sales incentive distribution and clearinghouse system;

FIG. 6 is a flowchart of methods and systems for receipt of incentives provided by a retailer or manufacturer, according to a possible embodiment of the present disclosure;

FIG. 7 shows an example vendor sign-in user interface, according to a possible embodiment of the present disclosure;

FIG. 8 shows an example incentive campaign creation user interface, according to a possible embodiment of the present disclosure;

FIG. 9 shows an example incentive campaign creation confirmation user interface, according to a possible embodiment of the present disclosure;

FIG. 10 shows an example incentive creation user interface of a series of user interfaces for manual incentive creation, according to a possible embodiment of the present disclosure;

FIG. 11 shows a second example incentive creation user interface of a series of user interfaces for manual incentive creation, according to a possible embodiment of the present disclosure;

FIG. 12 shows a third example incentive creation user interface of a series of user interfaces for manual incentive creation, according to a possible embodiment of the present disclosure;

FIG. 13 shows a fourth example incentive creation user interface of a series of user interfaces for manual incentive creation, according to a possible embodiment of the present disclosure;

FIG. 14 shows an example incentive creation user interface of a series of user interfaces for automated incentive creation, according to a possible embodiment of the present disclosure;

FIG. 15 shows a second example incentive creation user interface of a series of user interfaces for automated incentive creation, according to a possible embodiment of the present disclosure;

FIG. 16 shows a third example incentive creation user interface of a series of user interfaces for automated incentive creation, according to a possible embodiment of the present disclosure;

FIG. 17 shows a fourth example incentive creation user interface of a series of user interfaces for automated incentive creation, according to a possible embodiment of the present disclosure;

FIG. 18 shows a fifth example incentive creation user interface of a series of user interfaces for automated incentive creation, according to a possible embodiment of the present disclosure;

FIG. 19 shows an example reporting user interface, according to a possible embodiment of the present disclosure;

FIG. 20 shows an example incentive provider user administration interface, according to a possible embodiment of the present disclosure;

FIG. 21 shows an example incentive provider company administration interface, according to a possible embodiment of the present disclosure;

FIG. 22 shows an example customer registration user interface, according to a possible embodiment of the present disclosure;

FIG. 23 shows an example customer sign-in user interface, according to a possible embodiment of the present disclosure;

FIG. 24 shows a first example rendering of a customer item input user interface, according to a possible embodiment of the present disclosure;

FIG. 25 shows a second example rendering of a customer item input user interface, according to a possible embodiment of the present disclosure;

FIG. 26 shows a third example rendering of a customer item input user interface, according to a possible embodiment of the present disclosure;

FIG. 27 shows a fourth example rendering of a customer item input user interface, according to a possible embodiment of the present disclosure;

FIG. 28 shows an example shopping list printout and incentive printout, according to a possible embodiment of the present disclosure;

FIG. 29 shows a user account settings interface, according to a possible embodiment of the present disclosure; and

FIG. 30 shows a user sort settings interface, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to an electronic sales incentive distribution and clearinghouse system. The example system as described herein provides a central location for customers and incentive providers to exchange information, for example to allow distribution of incentives to customers. Incentive providers, in the context of the present disclosure, relates to retailers, manufacturers, or other suppliers of products or services (i.e., “items”) who provide some type of incentive (e.g., sales offer, coupon, discounts, rebates, etc) to purchase the product or service offered by that retailer, manufacturer, or other supplier. In certain embodiments, the present disclosure contemplates management of incentive campaigns by incentive providers, which may include one or more incentives, and may include other limitations or definitional features (e.g., term of a campaign, theme, etc.)

The systems and methods of the present disclosure allow a consumer to focus on the items they need to buy, rather than the incentives that are offered. Once the consumer enters items to buy into a list, the systems and methods described herein allow that customer to be presented with available incentives related to those items. They can then accept any incentive as desired, which can be immediately printed for subsequent use, stored until the list is printed and consumer is ready to shop, or substituted for other related offers or incentives. The systems and methods described herein therefore provide an efficient way for customers to manage coupons and other incentives in a manner coordinated with their lists of items to be purchased; instead of multiple, unconsolidated lists of items and incentives.

The present disclosure further relates to a central repository for items needing to be purchased, lists and coupons/incentives. These incentives are stored until the customer is ready to use them, and sorts their layout to match a preferred layout associated with a particular retailer or manufacturer. This saves consumer time in use of incentives, locating items on their list in relation to their location in a store, in preparation of lists of items to purchase, and in providing those incentives for use at the retailer or manufacturer.

Additional advantages are also provided in accordance with the systems and methods of the present disclosure. The system also provides external information to customers, manufacturers, and retailers alike, for example relating to product safety or nutrition information, product recall information, retailer issues (e.g., hours, stock, etc.) or other information relating to any of the customers, manufacturers, retailers, or products alike. For example, and as described in further detail below, product alert information can be provided to customers, for example in the case of unsafe or recalled products.

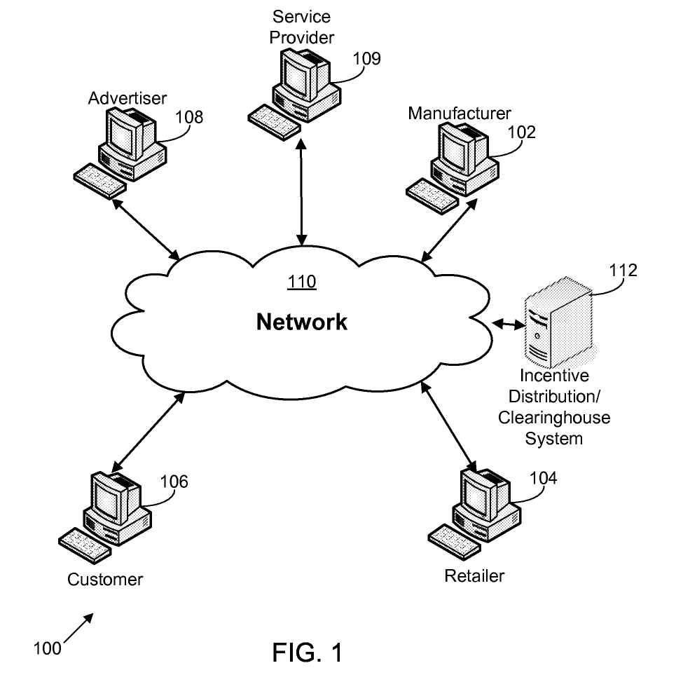

Referring now to FIG. 1, a logical diagram of an electronic sales incentive distribution network 100 is shown, in which aspects of the present disclosure can be implemented. The electronic sales incentive distribution network 100 includes a plurality of entities capable of providing products for purchase by customers. In the example embodiment, the electronic sales incentive distribution network 100 includes a manufacturer 102, a retailer 104, a customer 106, an advertiser 108, and a service provider 109 communicatively connected via network 110 to an incentive distribution and clearinghouse system 112.

The example manufacturer 102, retailer 104, and service provider 109 correspond to entities capable of providing items for sale to prospective customers. The manufacturer 102 could, in certain embodiments, correspond to manufacturers of products or constituent parts of products, such that items purchased by a customer may utilize a component made by the manufacturer. The retailer 104 may correspond to a seller or reseller of products and/or services, or constituent parts thereof. The service provider 109 can correspond to an entity. Both the manufacturer 102 and retailer 104 provide incentives for use by a customer, for example, by authorizing printing of coupons for inclusion in a circular or other publication to be sent to the customer and intended to promote the products/services provided by that manufacturer and/or retailer. The example customer 106 refers to a prospective customer of one or more of the incentive providers associated with the incentive distribution and clearinghouse system 112, such as the manufacturer 102, retailer 104, or advertiser 108. A customer, or consumer, refers to an individual, household, or other individual seeking to buy the products or services provided by incentive providers and other retailers or manufacturers.

The example advertiser 108 corresponds to an entity wishing to advertise products or services to one or more of the manufacturer 102, retailer 104, customer 106, or service provider 109. For example, the advertiser 108 may wish to communicate information regarding peripheral products or services to a customer in the instance where that customer indicates interest in a product from a manufacturer or retailer. Alternatively, the advertiser 108 may wish to communicate information to the retailer or service provider regarding new products to carry or offer for sale, constituent parts or services for use by a manufacturer, or new services to provide based on available products/services. Other alternative reasons for communication to the manufacturer, retailer, and/or customer exist as well.

Although one of each of the above types of entities are disclosed in FIG. 1, it is understood that a variety of different manufacturers, retailers, customers, and advertisers are typically included within an electronic sales incentive distribution network 100. Additionally, one or more of the manufacturer, retailer, or advertiser may be absent in certain embodiments of the present disclosure.

Each of the entities and users described in conjunction with FIG. 1 (e.g., manufacturer 102, retailer 104, customer 106, and advertiser 108) is represented as a computing system of various types. In various embodiments, these components of the example electronic sales incentive distribution network 100 may correspond to one or more computing systems at those locations or controlled by those entities, or could alternately represent those entities themselves.

The example network 110 may be any of a number of communicative connections between computing systems, and can include any of a number of combinations of such communicative connections. For example, the network 110 can correspond to a LAN, WAN, wireless mesh network, or any similar network. In certain embodiments, the network 110 corresponds to the Internet.

The example incentive distribution and clearinghouse system 112 provides a generally accessible location at which the manufacturer 102, retailer 104, and service provider 109 can make available incentives for access by a customer 106 wishing to prepare a list of items to be purchased (e.g., a “grocery list”). For example, and as discussed in further detail below, the incentive distribution and clearinghouse system 112 can be configured to receive a list of items from a customer 106, and can match each of those items to one or more possible incentives, such as coupons or other discounts, for particular products from manufacturers, retailers or service providers for the same or similar products or services (e.g., substitutable products/services). The customer can elect to use one or more of those incentives, and the incentive distribution and clearinghouse system 112 can save those incentives in a manner integrated with that customer's list. At the time the customer elects to shop, the incentive distribution and clearinghouse system 112 can provide an integrated list and set of incentives that can be used, including incentives elected by the customer.

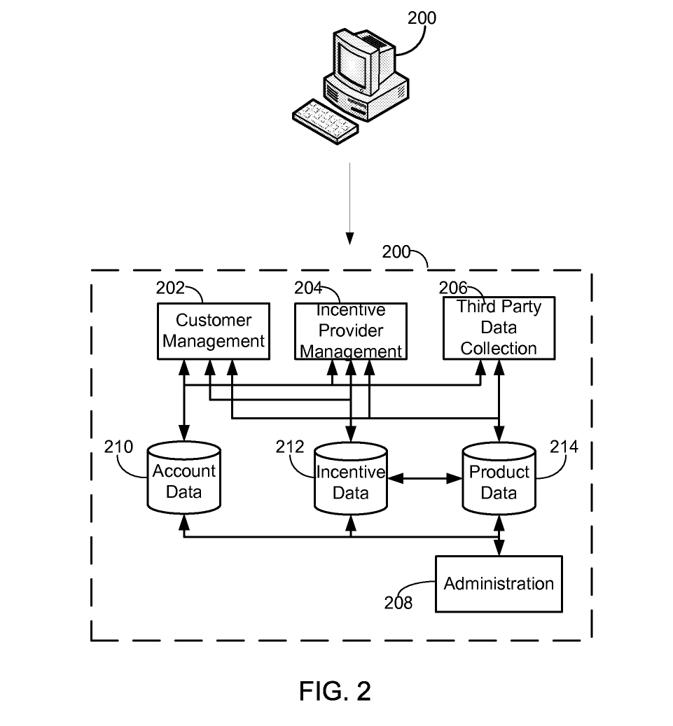

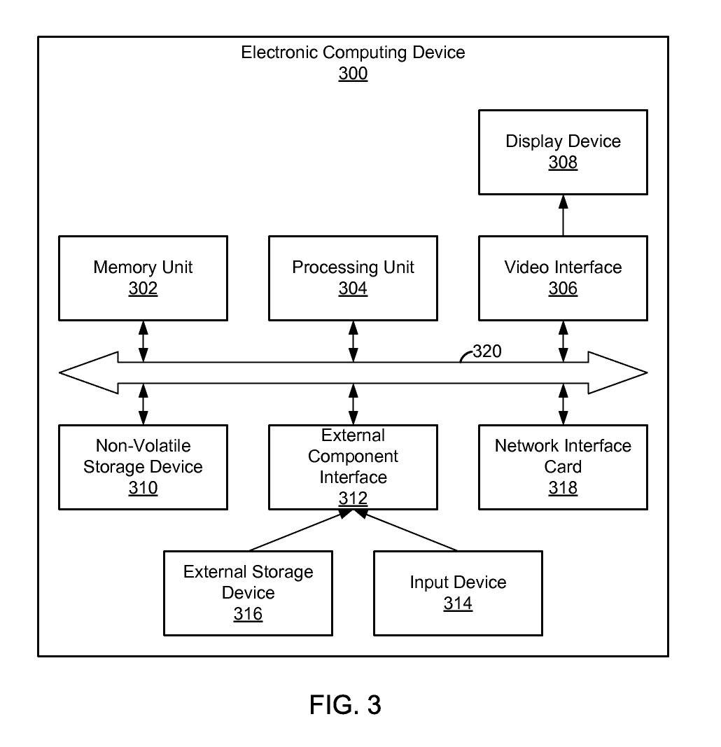

The incentive distribution and clearinghouse system 112 generally includes a computing system that can be communicatively accessed by each of the other entities illustrated in FIG. 1. An example of a possible incentive distribution and clearinghouse system 112 is described below in connection with FIGS. 2 and 3.

FIG. 2 is a logical diagram of an electronic sales incentive distribution and clearinghouse system 200, according to a possible embodiment of the present disclosure. The example incentive distribution and clearinghouse system 200 can, in certain embodiments, correspond to the incentive distribution and clearinghouse system 112 of FIG. 1.

In the embodiment shown, the incentive distribution and clearinghouse system 200 includes a customer management module 202, an incentive provider management module 204, a third party data collection module 206, and an administration module 208. The example customer management module 202 presents a number of user interfaces to a customer, allowing the customer to sign-in to the incentive distribution and clearinghouse system 200 and create one or more lists of items (e.g., “shopping lists”) including items that the customer wishes to purchase.

The customer management module 202 also merges incentive information with those lists and presents incentives for selection by the customer relating to the items on the list, or related items. For example, a user may enter an item (e.g., “rye bread”) on a list for a grocery item and the customer management module 202 can determine that there is an available incentive on a particular type or brand of the grocery item of interest. That incentive could be offered to the customer, optionally alongside other incentives on other brands or types of the grocery item of interest (e.g., “wheat bread”) that the customer may opt to purchase as a substitute for the item on the list.

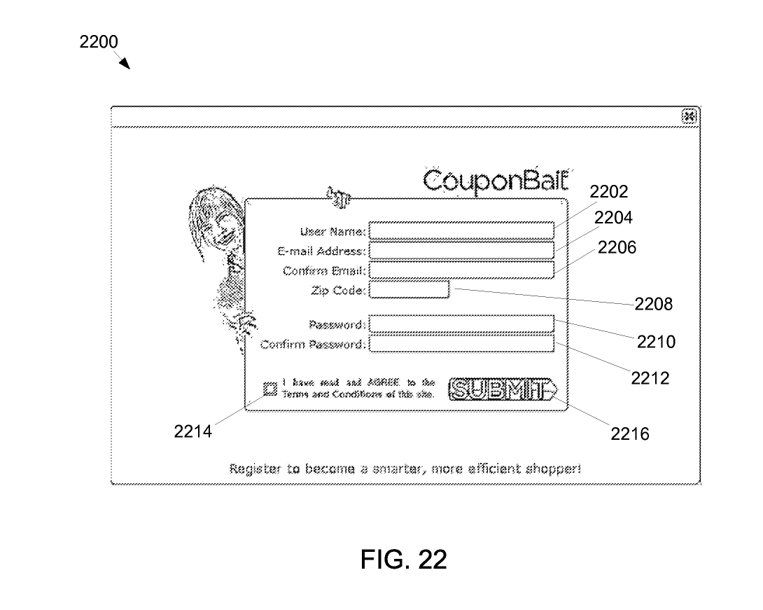

The customer management module 202 can perform this matching process a variety of different ways. In certain embodiments, the customer management module 202 executes logic to match each item on a customer's list to one or more incentives that are for a specific brand or for a specific retailer of that item. In further embodiments, the customer management module 202 executes logic to match incentives to a predetermined number of items on the customer's list of items (e.g., all or less than all of the items on the list). In still other embodiments, the customer management module 202 executes logic to suggest additional or competing products for the customer to buy, and for which incentives may or may not exist (e.g., depending on whether the provider of the additional product acts as an advertiser or an incentive provider). The choice of whether to display incentives relating to matching items, competing items, or “add-on” items may be variable, and can be edited within user interfaces of the incentive distribution and clearinghouse system 200, for example by an incentive provider or an administrator. Additionally, other possibilities exist regarding the methods for matching incentives to products, as described in further detail below. An example set of user interfaces of the customer management module 202 are described below in connection with FIGS. 22-30.

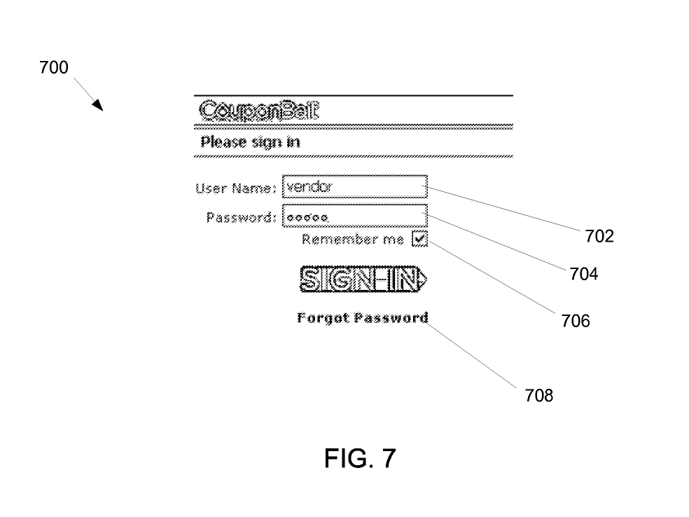

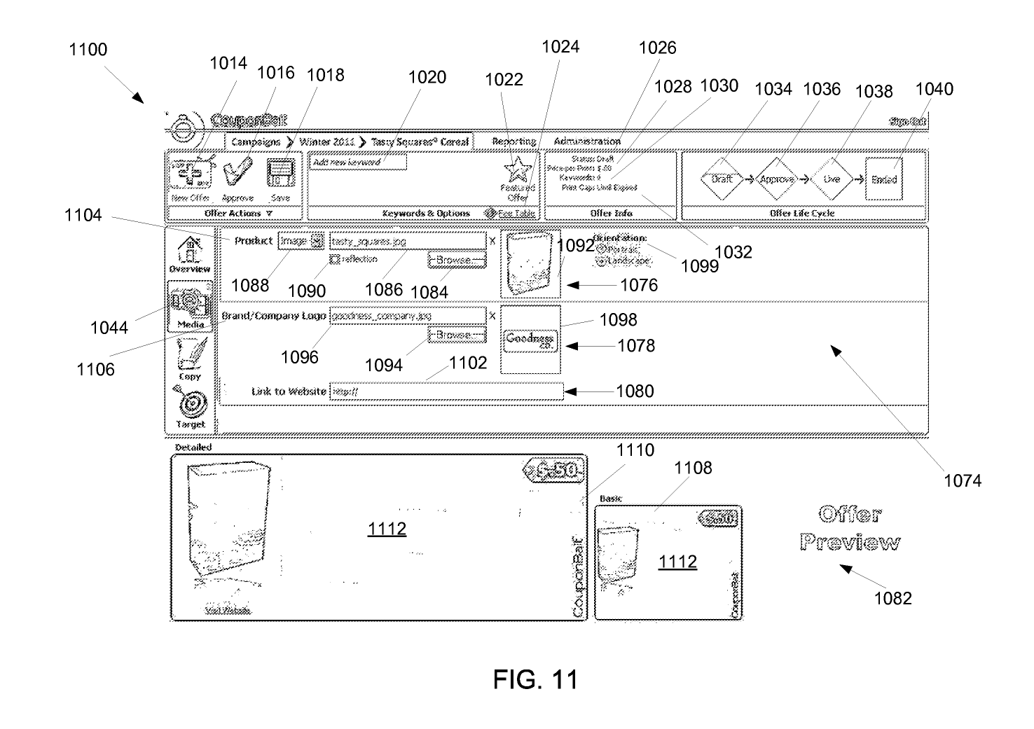

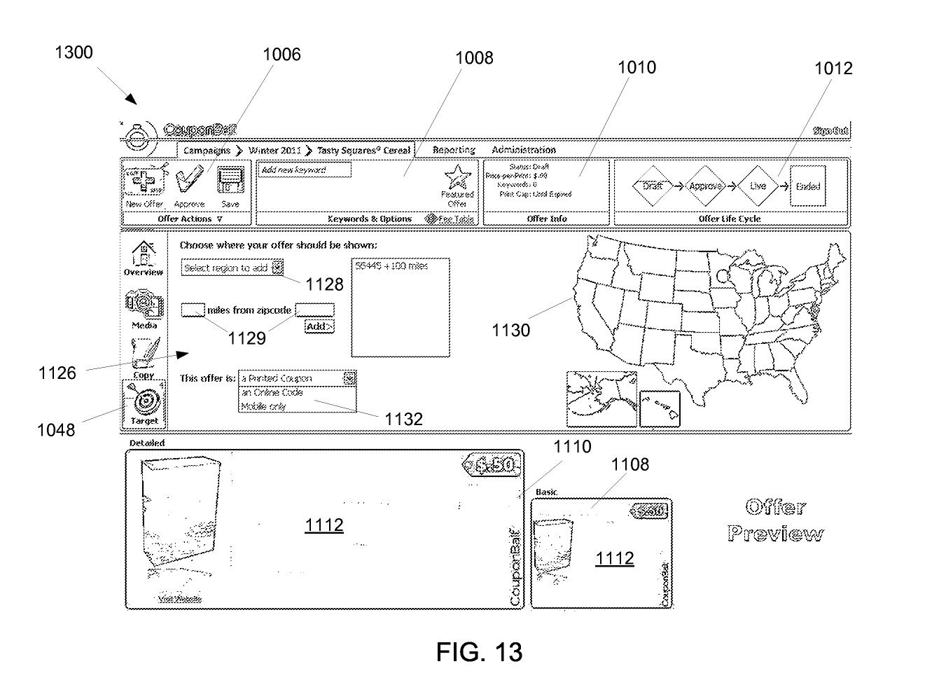

The example incentive provider management module 204 presents a number of user interfaces to an incentive provider, allowing the incentive provider to sign-in to the incentive distribution and clearinghouse system 200, create a draft of different offers, and manage both active offers corresponding to the incentives that they are currently offering and non-active offers corresponding to draft offers. For example, in some embodiments, an incentive provider will enter an incentive (e.g., an e-coupon or other type of sales incentive or discount) into a user interface of the incentive provider management module 204. Typically, that incentive will identify a particular product and its provider (e.g., the retailer, manufacturer or service provider), as well as a reimbursable amount of the incentive. Those incentives will then be presented to a customer via the customer management module 202. An example set of user interfaces associated with the incentive provider management module 204 are described below in conjunction with FIGS. 7-18.

In certain embodiments, the incentive provider management module 204 can also accept preferences regarding the manner in which the incentive is offered to customers. For example, the incentive could be provided to customers entering a generic name for an item, where the incentive relates to a particular brand or source of the product. Or, the incentive could be provided to customers entering a name of a competing or substitute product. Or, the incentive could be provided to customers entering the name of a related product. For example, using the interfaces and modules described herein, a user entering a name brand product (e.g., “Pepsi”) could be presented with a number of incentives related to that product from a variety of retailers, and optionally also display incentives from those vendors or other sources for competing products (e.g., Coke, or other house brand colas). Other possibilities exist as well.

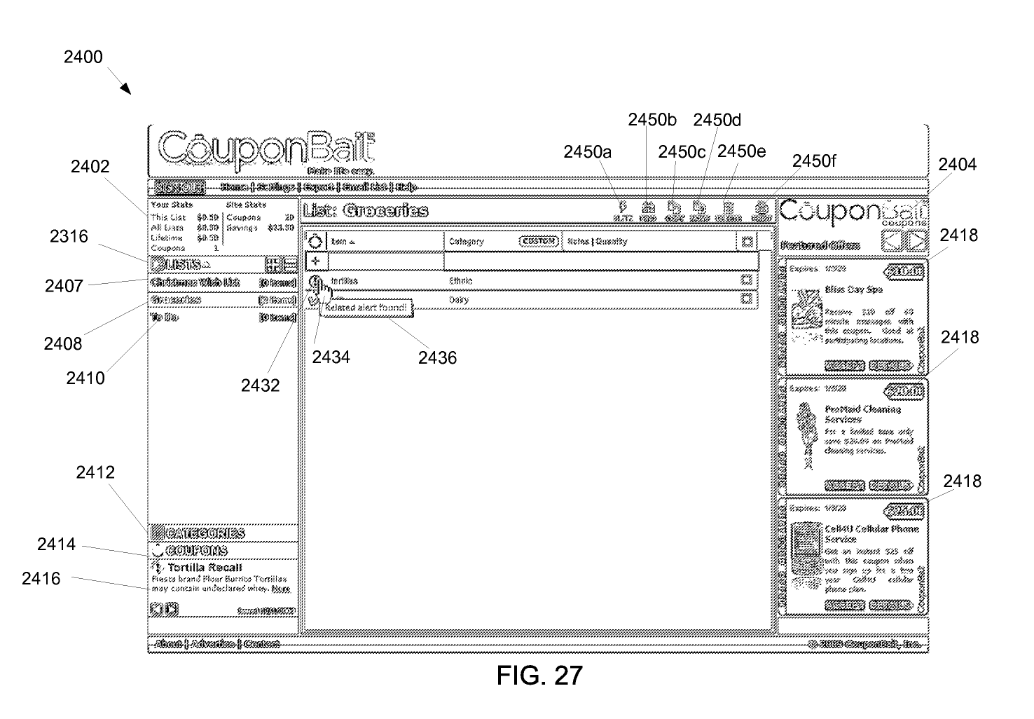

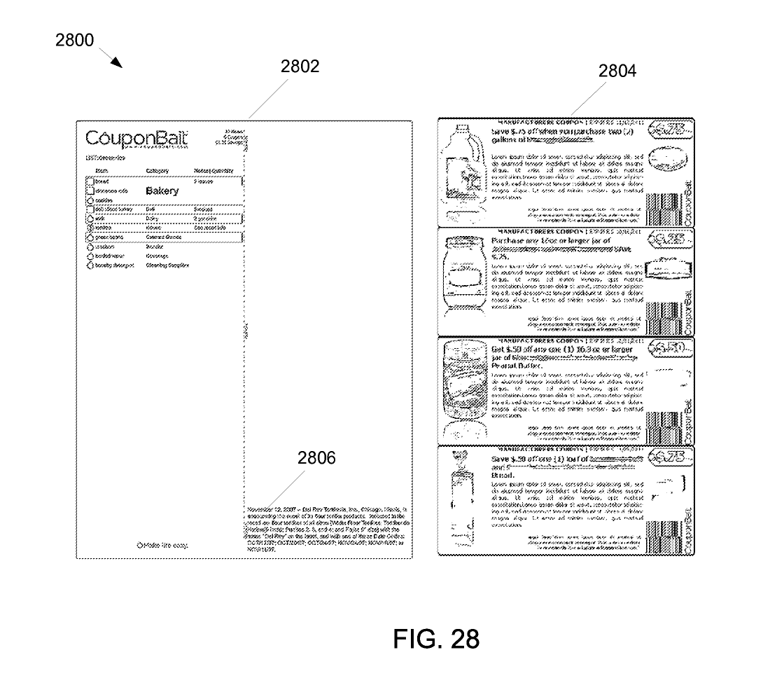

The example third party data collection module 206 collects information from one or more third party entities relating to the products and incentives tracked by the incentive distribution and clearinghouse system 200. It will be appreciated that such information collected from third party entities can take any of a number of forms. For example, in one possible embodiment, the third party data collection module 206 is configured to collect publicly-available health and nutrition information regarding the products described by the incentives, allowing customers to view comparative health information when making a decision as to whether to accept an incentive and purchase a product. In another possible embodiment, the third party data collection module 206 is configured to collect product recall or safety warning information regarding particular products or brands of products, thereby informing consumers that purchase of those products (or past purchase of those products) may be problematic. Examples of such information are illustrated in FIGS. 27-28, below.

In still another embodiment, the third party data collection module 206 can collect advertising information from third parties (e.g., retailers not presenting incentives) to advertise similar or complementary products to those entered by the customer or to which one or more incentives relate, for example to allow those advertisers to encourage sales of products without providing some type of price incentive. In still a further embodiment, the third party data collection module 206 can collect information from advertisers regarding products or services to be provided to retailers or service providers. For example, add-on services or other convoyed/packaged sales arrangements could be formed in which a product and associated service could be packed for resale. Other third party information could be collected and distributed to customers and incentive providers as well.

The example administration module 208 allows an administrative user to edit various settings relating to the incentive distribution and clearinghouse system 200. For example, in a possible embodiment, the administration module 208 allows an administrator to view and edit user account information, including customer account information and incentive provider account information. The administration module 208 also provides user interfaces capable of displaying usage statistics, and allowing an administrator to edit logic used to connect incentives to products entered by a user, for example based on a level of service provided to a particular incentive provider (e.g., rights to offer incentives on similar but substitutable products, rights to offer incentives on add-on products, rights to offer incentives only when a generic product is identified by a customer). Other incentive settings could be set by an administrator as well.

In addition to the functional modules described above in connection with FIG. 2, the incentive distribution and clearinghouse system 200 includes various data stores storing data such as account data 210, incentive data 212, and product data 214. In example embodiments, the account data 210 includes information relating to accounts of retailers, manufacturers, service providers, advertisers, and customers, such as those described above in conjunction with FIG. 1. For example, the account data 210 can include user identification and credentials (e.g., a password) for each user associated with these entities, as well as information specific to the type of entity accessing the incentive distribution and clearinghouse system 200. For example, for customers, the account data can include the name, address, and other identifying information of the customer and lists of items to be purchased by the customer, as entered by the customer. Additional information could be included as well, including, for example, trend information regarding items purchased by the customer, customer display preferences regarding the interface presented by the incentive distribution and clearinghouse system 200, and other settings. Relating to an incentive provider, the account data 210 for each incentive provider can include the name and contact information of an individual associated with the incentive provider, access rights of that user (e.g., within a hierarchy of access rights provided to users at the incentive provider) and other account-based information.

The incentive data 212 can be received from the customers and incentive providers, and relates to the incentives received, stored, and distributed by the incentive distribution and clearinghouse system 200. The incentive data 212 can include, for example, information about incentives as received from incentive providers, including an amount of each incentive, the product or products to which each incentive relates, and the valid dates for each incentive; historical data regarding incentives used by the customer; and information regarding the type of products with which to display the incentive (e.g., via associated logic referenced above). Other information can be included as well.

The product data 214 can be received from incentive providers, customers, third parties, or publicly available sources. In various embodiments, the product data 214 includes data relating to products possibly offered for sale by retailers or manufacturers, such as name, location, item price (e.g., with and without incentives), incentives, valid price dates. In certain embodiments, the product data 214 can include nutritional information gathered from the retailer, manufacturer, service provider, customer-entry, or third-party, public source of information. The product data can also include product usage advisories or safety information relating to one or more products, such that when a customer selects a product for purchase (e.g., whether or not associated with an incentive), that customer receives a notification of a possible safety hazard or usage advisory associated with that product. Other information can be included in the product data 214 as well.

Overall, and as described in connection with particular embodiments of the incentive distribution and clearinghouse system 200 below, an incentive provider can publish one or more incentives relating to items within the incentive distribution and clearinghouse system 200 via the incentive provider management module 204, and customers can build lists (e.g., “shopping lists”) of items to purchase using a user interface generated by the customer management module 202. The customer is presented with one or more of the incentives from a variety of incentive providers, and can review and select appropriate incentives. The specific incentives displayed to the user may vary due to the business logic employed. When the customer wishes to purchase items, for example on a shopping trip to a grocery store or other retailer, that customer can either print his or her list and linked group of selected incentives for use at the retailer. In some embodiments, the customer can carry both the list and incentives electronically, and can electronically communicate those incentives to the retailer at the time of checkout (e.g., via bar code, electronic data transmission, or other means).

Although in the embodiment shown a particular set of modules and data stores is illustrated, it is understood that additional functional modules and additional data stores could be incorporated as well, for example to extend the functionality of the incentive distribution and clearinghouse system 200.

FIG. 3 is a block diagram illustrating example physical components of an electronic computing device 300, which can be used to execute the various operations, described above, and can be any of a number of the devices described in FIGS. 1 and 2 and including any of a number of types of communication interfaces as described herein. A computing device, such as electronic computing device 300, typically includes at least some form of computer-readable media. Computer readable media can be any available media that can be accessed by the electronic computing device 300. By way of example, and not limitation, computer-readable media might comprise computer storage media and communication media.

As illustrated in the example of FIG. 3, electronic computing device 300 comprises a memory unit 302. Memory unit 302 is a computer-readable data storage medium capable of storing data and/or instructions. Memory unit 302 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 300 comprises a processing unit 304. As mentioned above, a processing unit is a set of one or more physical electronic integrated circuits that are capable of executing instructions. In a first example, processing unit 304 may execute software instructions that cause electronic computing device 300 to provide specific functionality. In this first example, processing unit 304 may be implemented as one or more processing cores and/or as one or more separate microprocessors. For instance, in this first example, processing unit 304 may be implemented as one or more Intel Core 2 microprocessors. Processing unit 304 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 304 may be implemented as an ASIC that provides specific functionality. In a third example, processing unit 304 may provide specific functionality by using an ASIC and by executing software instructions.

Electronic computing device 300 also comprises a video interface 306. Video interface 306 enables electronic computing device 300 to output video information to a display device 308. Display device 308 may be a variety of different types of display devices. For instance, display device 308 may be a cathode-ray tube display, an LCD display panel, a plasma screen display panel, a touch-sensitive display panel, a LED array, or another type of display device.

In addition, electronic computing device 300 includes a non-volatile storage device 310. Non-volatile storage device 310 is a computer-readable data storage medium that is capable of storing data and/or instructions. Non-volatile storage device 310 may be a variety of different types of non-volatile storage devices. For example, non-volatile storage device 310 may be one or more hard disk drives, magnetic tape drives, CD-ROM drives, DVD-ROM drives, Blu-Ray disc drives, or other types of non-volatile storage devices.

Electronic computing device 300 also includes an external component interface 312 that enables electronic computing device 300 to communicate with external components. As illustrated in the example of FIG. 3, external component interface 312 enables electronic computing device 300 to communicate with an input device 314 and an external storage device 316. In one implementation of electronic computing device 300, external component interface 312 is a Universal Serial Bus (USB) interface. In other implementations of electronic computing device 300, electronic computing device 300 may include another type of interface that enables electronic computing device 300 to communicate with input devices and/or output devices. For instance, electronic computing device 300 may include a PS/2 interface. Input device 314 may be a variety of different types of devices including, but not limited to, keyboards, mice, trackballs, stylus input devices, touch pads, touch-sensitive display screens, or other types of input devices. External storage device 316 may be a variety of different types of computer-readable data storage media including magnetic tape, flash memory modules, magnetic disk drives, optical disc drives, and other computer-readable data storage media.

In the context of the electronic computing device 300, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 302, non-volatile storage device 310, or external storage device 316, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 300.

In addition, electronic computing device 300 includes a network interface card 318 that enables electronic computing device 300 to send data to and receive data from an electronic communication network. Network interface card 318 may be a variety of different types of network interface. For example, network interface card 318 may be an Ethernet interface, a token-ring network interface, a fiber optic network interface, a wireless network interface (e.g., WiFi, WiMax, etc.), or another type of network interface.

Electronic computing device 300 also includes a communications medium 320. Communications medium 320 facilitates communication among the various components of electronic computing device 300. Communications medium 320 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 320, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 300 includes several computer-readable data storage media (i.e., memory unit 302, non-volatile storage device 310, and external storage device 316). Together, these computer-readable storage media may constitute a single data storage system. As discussed above, a data storage system is a set of one or more computer-readable data storage mediums. This data storage system may store instructions executable by processing unit 304. Activities described in the above description may result from the execution of the instructions stored on this data storage system. Thus, when this description says that a particular logical module performs a particular activity, such a statement may be interpreted to mean that instructions of the logical module, when executed by processing unit 304, cause electronic computing device 300 to perform the activity. In other words, when this description says that a particular logical module performs a particular activity, a reader may interpret such a statement to mean that the instructions configure the electronic computing device such that the electronic computing device 300 performs the particular activity.

One of ordinary skill in the art will recognize that additional components, peripheral devices, communications interconnections and similar additional functionality may also be included within the electronic computing device 300 without departing from the spirit and scope of the present invention as recited within the attached claims.

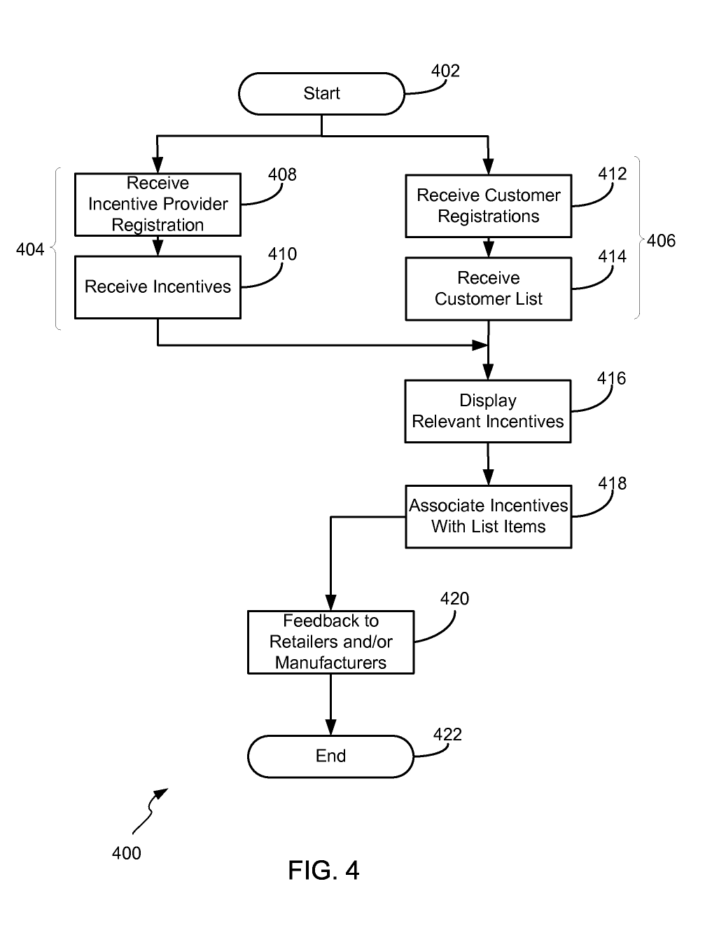

Referring now to FIGS. 4-6, flowcharts of methods and systems for use and implementation of an incentive distribution clearinghouse system are described. The methods and systems of FIGS. 4-6 can, in certain embodiments, operate using the hardware systems described above in connection with FIGS. 1-3.

FIG. 4 is a flowchart of an example method 400 for managing electronic sales incentives, according to a possible embodiment of the present disclosure. In some embodiments, the method 400 is implemented by the incentive distribution and clearinghouse system 200 of FIG. 2, as described above. However, other embodiments are possible as well.

The example method 400 is instantiated at a start operation 402. The start operation 402 corresponds to initial availability of the sales incentive distribution and clearinghouse system to customers and incentive providers for use. Following the start operation 402, the method 400 is initially branched into an incentive provider branch 404 and a customer branch 406. In general, operational flow within the incentive provider branch 404 is asynchronous and independent of operational flow within the customer branch 406, as described in further detail below.

The incentive provider branch 404 includes an incentive provider registration operation 408 and an incentive receipt operation 410. At the incentive provider registration operation 408, the incentive distribution and clearinghouse system 200 receives registration and/or sign-in information from an incentive provider (e.g., a retailer, manufacturer, vendor or other supplier) with intention of managing electronic sales incentives. In some embodiments, an incentive provider enters the registration and/or sign-in information into a dedicated user interface associated with the incentive provider management module 204 of FIG. 2, above. An example of such a user interface is described below in connection with FIG. 7.

Optionally, the incentive provider registration operation 408 includes a verification process in which the incentive distribution and clearinghouse system 200 validates that a user is in fact associated with an incentive provider, and assigns a level of rights to that user. For example, in certain embodiments, the incentive provider registration operation 408 includes transmitting a confirmation message to an email account of the user to verify his/her identity, and optionally a confirmation message to a known user associated with the entity requesting that the user be authorized.

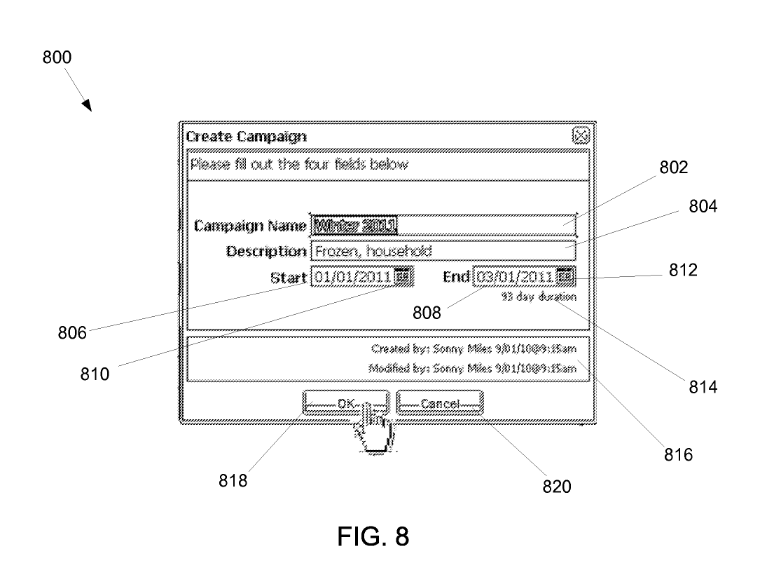

Following receipt of registration and/or sign-in information from an incentive provider at the incentive provider registration operation, operational flow proceeds to the incentive receipt operation 410 at which one or more incentives are received at the incentive distribution and clearinghouse system 200. For example, in some embodiments, an incentive provider accesses a series of user interfaces to create and/or modify incentives or offers. In general, incentives can be created and/or modified via a manual process in which data associated with a particular incentive is entered manually into the incentive distribution and clearinghouse system 200; alternately, incentives can be created and/or modified by an automatic process in which data associated with a particular incentive is imported or loaded to the incentive distribution and clearinghouse system 200 from a pre-existing data file or folder. Example user interfaces accessed by an incentive provider to create and/or modify incentives are described below in connection with FIGS. 8-18, respectively. In example embodiments, such user interfaces are associated with the incentive provider management module 204 of FIG. 2, as described above.

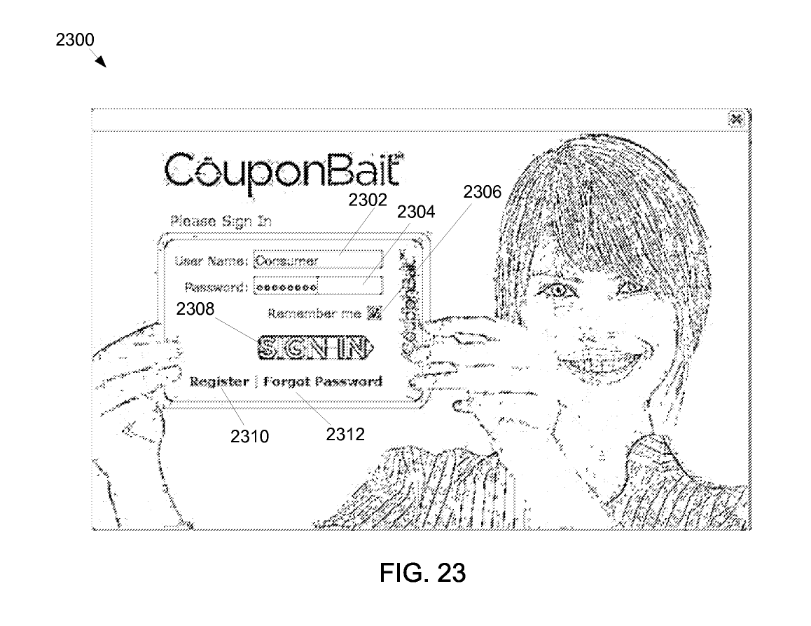

Referring now to the example customer branch 406, which includes a customer registration operation 412 and a customer list receipt operation 414. At the customer registration operation 412, the incentive distribution and clearinghouse system 200 receives registration and/or sign-in information from a customer (e.g., an individual, household, or other customer seeking to buy the products or services, whether provided by incentive providers or other retailers or manufacturers). In some embodiments, a customer enters the registration and/or sign-in information into a dedicated user interface associated with customer management module 202 of FIG. 2, as described above. An example of such a user interface is described below in connection with FIGS. 22 and 23, respectively.

Optionally, the customer registration operation 412 also includes a verification process in which the incentive distribution and clearinghouse system 200 validates that a user is in fact the person indicated by the entered information. For example, in certain embodiments, the customer registration operation 412 includes transmitting a confirmation message to an email account of the user to verify his/her identity.

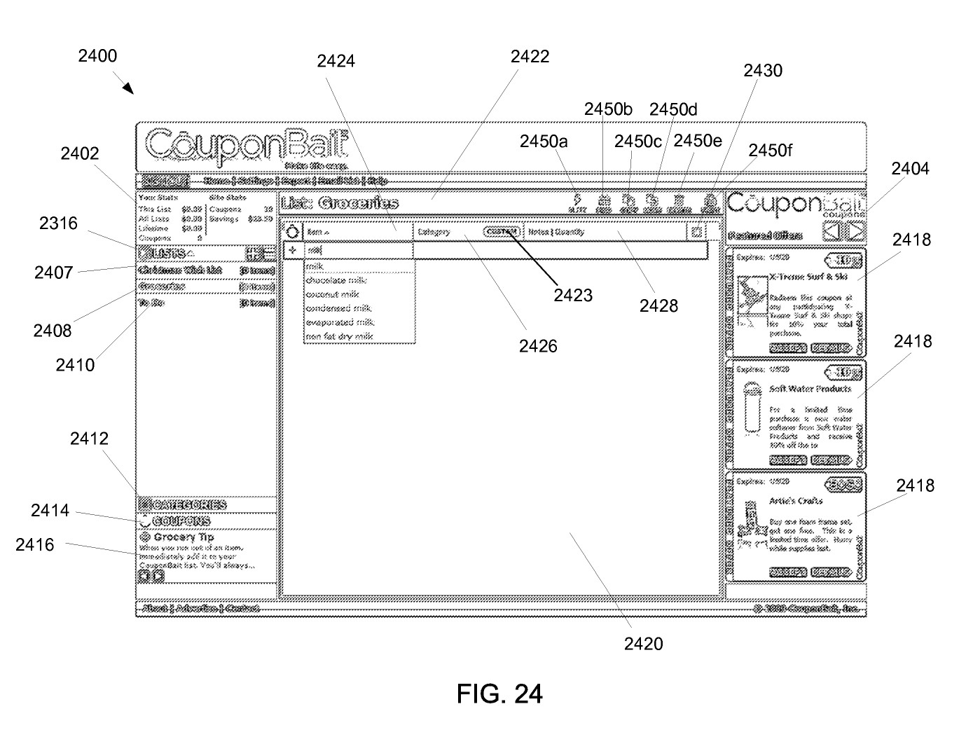

Following receipt of registration and/or sign-in information from a customer at the customer registration operation 412, operational flow proceeds to the customer list receipt operation 414. At the customer list receipt operation 414, one or more item selections (e.g., products or services) are received at the incentive distribution and clearinghouse system 200 from the customer. In some embodiments, a customer can enter a desired item for purchase (e.g., grocery item) into a list (e.g., grocery list) via a dedicated user interface associated with customer management module 202 of FIG. 2, as described above. In such embodiments, the user can enter a complete or partial description of an item, including a brand name describing the item, a partial item name, or other identifier. Also in such embodiments, the customer can optionally be displayed a list of suggested items for selection based on user entry. An example of such a user interface is described below in connection with FIGS. 24-27, respectively.

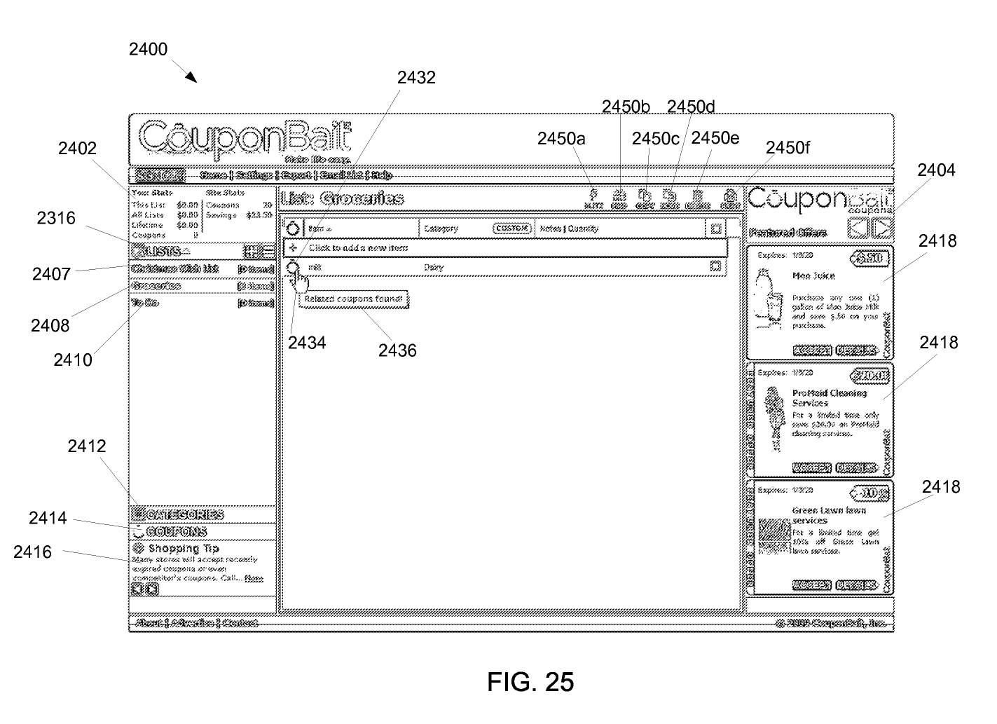

Following the incentive receipt operation 410 and/or the customer list receipt operation 414, operational flow proceeds to an incentive association operation 416. At the incentive association operation 416, the incentive distribution and clearinghouse system 200 identifies and displays relevant incentives, such as received at the incentive receipt operation 410, associated with the one or more item selections or item inputs received at the customer list receipt operation 414. In certain embodiments, the incentive association operation 416 determines a match between entered items and incentives, and, when such a match is determined, displays an icon or other notification to a user that incentives are available. The incentive association operation 416 can, in such embodiments, operate within a common user interface alongside the customer list receipt operation 414. An example of such a user interface in which a user can be notified of available incentives is described further below in connection with FIG. 25.

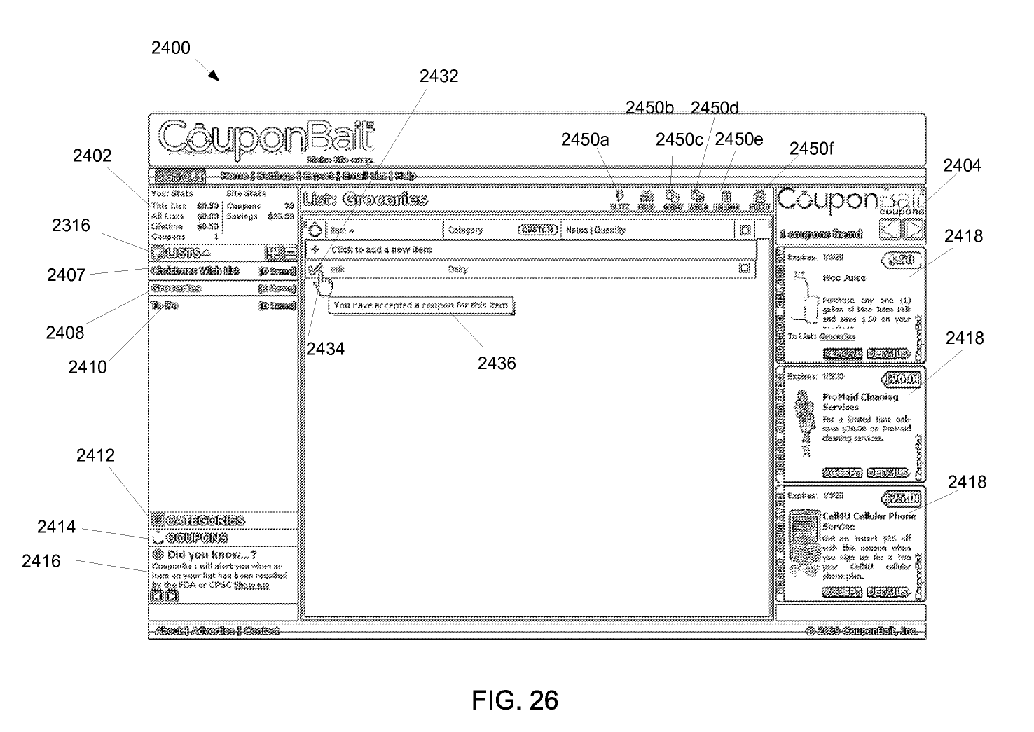

Operational flow then proceeds to an incentive distribution operation 418. At the incentive distribution operation 418, the incentive distribution and clearinghouse system 200 associates an incentive selected by a customer with a specific item request of the one or more item selections received at the customer list receipt operation 414. For example, in some embodiments, a customer can select the displayed icon or notification displayed by the incentive association operation 416 to associate that item with the customer and one or more items in the customer's list. In such embodiments, the icon or other notification provided by the incentive association operation 416 can be modified to represent an accepted incentive, as illustrated in the user interfaces below. An example of such user interface can be associated with the customer management module 202 of FIG. 2 and is described further below in connection with FIG. 26.

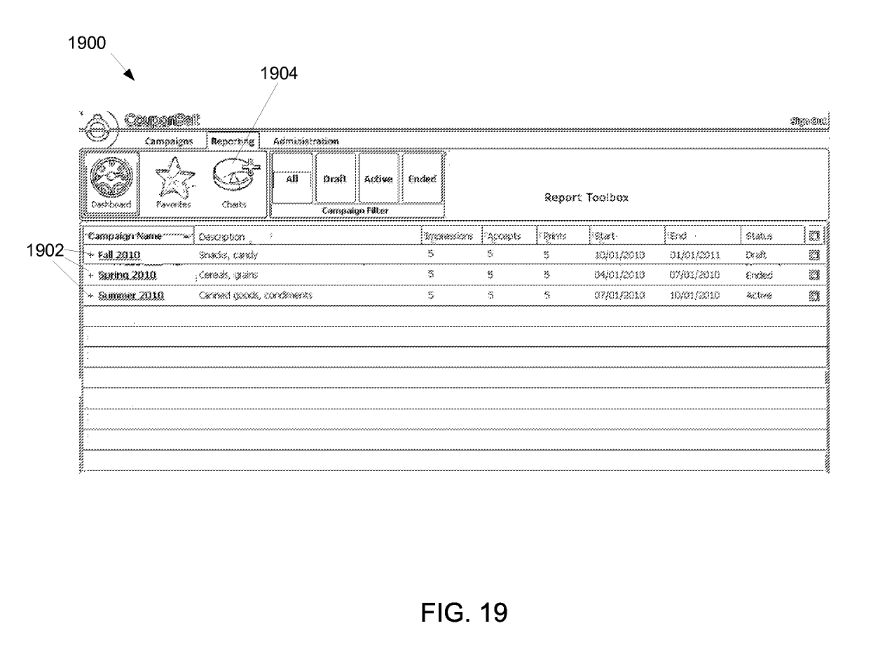

Operational flow proceeds to a feedback operation 420. At the feedback operation 420, the incentive distribution and clearinghouse system 200 consolidates and presents information related to an incentive and/or an item as selected at the incentive receipt operation 410 and the customer list receipt operation 414 to any of a customer, retailer vendor, or manufacturer as desired. For example in some embodiments, the incentive distribution and clearinghouse system 200 provides one or more reports related to an incentive and/or an item as selected at operations 410, 414. An example of such user interface can be associated with the administration module 208 of FIG. 2 and is described further below in connection with FIG. 19.

The overall method 400 terminates at an end operation 422, which relates to completed usage of the electronic sales incentive distribution and clearinghouse system by one or more users (e.g., an incentive provider or customer).

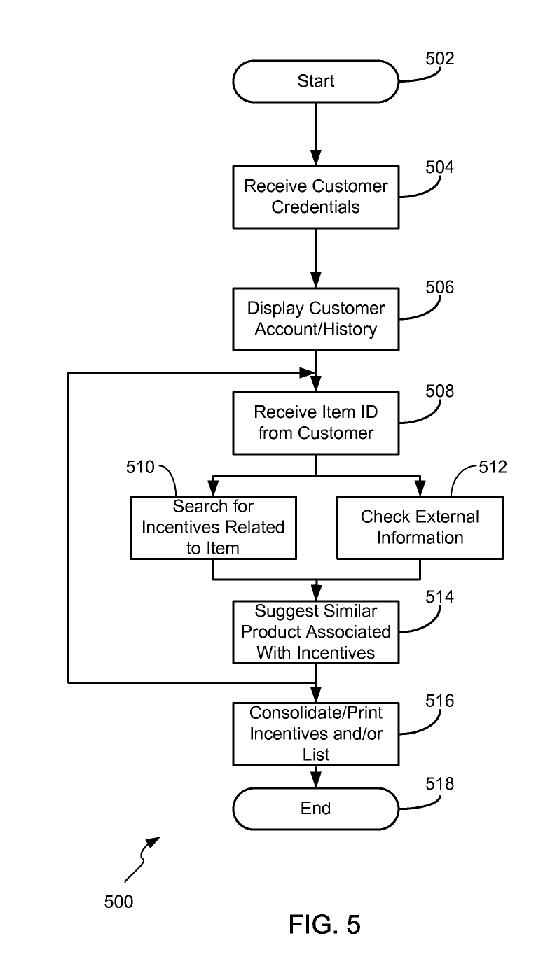

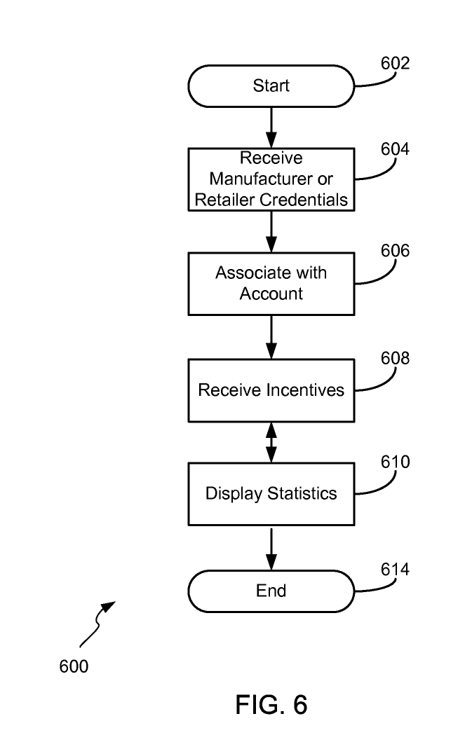

Referring to the example method 400 overall, although the method 400 is illustrated as registering a single incentive provider and receiving incentives from a single incentive provider, it is understood that in the typical operation of an electronic sales incentive distribution and clearinghouse system, many incentive providers will register with the system and provide incentives for viewing and selection by customers. Similarly, the method is illustrated as registering and receiving lists from a single customer; however, it is understood that this is intended to represent a single possible use of the overall method, which would occur many times and be accessed by many different customers. Therefore, operation of the incentive provider registration operation 408 and incentive receipt operation 410 will likely occur many times, for each incentive provider. Additionally, an incentive provider may choose to modify or add to the incentives they may provide, and therefore the incentive receipt operation 410 may occur many times for each incentive provider. Likewise, the customer registration operation 412 and the customer list receipt operation 414 will occur many times for different customers, and the customer list receipt operation 414 and subsequent modules 416-420 will occur many times per customer. Additional details regarding usage of an electronic sales incentive distribution and clearinghouse system by a customer are provided below in connection with FIG. 5; details regarding use of such a system by an incentive provider are described below in connection with FIG. 6.

Additionally, although a particular set of operations is illustrated in connection with FIG. 4, it is understood that additional operations could be included in the method 400 as well. For example, the electronic sales incentive distribution and clearinghouse system could account for tracking of purchases by a user, and therefore would receive sales data and sales preference data from one or more of the incentive providers.

FIG. 5 is a flowchart of an example method 500 for building a shopping list while including available sales incentives managed by an electronic sales incentive distribution and clearinghouse system. In some embodiments, the method 500 is implemented by the incentive distribution and clearinghouse system 200 described above in connection with FIG. 2. However, other embodiments are possible.

The example method 500 is instantiated at a start operation 502. The start operation 502 corresponds to initial availability of the sales incentive distribution and clearinghouse system to a customer for use. Following the start operation 502, operational flow proceeds to a receive credentials operation 504. At the credentials operation 504, the incentive distribution and clearinghouse system 200 receives registration and/or sign-in information from a customer (e.g., an individual, household, or other customer seeking to buy the products or services provided by incentive providers and other retailers or manufacturers). In some embodiments, a customer enters the registration and/or sign-in information into a dedicated user interface associated with the customer management module 202 of FIG. 2, as described above. An example of such a user interface is described below in connection with FIGS. 22 and 23, respectively. In example embodiments, the incentive distribution and clearinghouse system 200 correlates the customer with an associated user account upon receiving sign-in information from the customer at the receive credentials operation 504.

Following receipt of sign-in information from a customer at the credentials operation 504, operational flow proceeds to a display operation 506. At the display operation 506, the incentive distribution and clearinghouse system 200 displays one or more shopping lists, each of which are associated with a signed-in customer and containing one or more items (e.g., products or services). For example, in some embodiments, a customer can access a user interface associated with customer management module 202 of FIG. 2 that displays a shopping list. Examples of such user interfaces are described below in connection with FIGS. 22-27.

In certain embodiments, each list can have associated with it a set of categories of items by which that list can be sorted. In the display operation 506, the lists associated with that user can be displayed; if the user has not yet created any lists, a set of sample lists are optionally provided (e.g., Groceries, To Do, and Wish Lists).

Operational flow then proceeds to an item entry operation 508 at which the incentive distribution and clearinghouse system 200 receives an item selection or entry from the customer. For example, in some embodiments, a customer can enter or select an item (e.g., grocery item) on a shopping list, thereby designating the item as desired for purchase, into a dedicated interface associated with customer management module 202 of FIG. 2, as described above. An example of such a user interface is described below in connection with FIG. 24.

Following the item entry operation 508, process flow of the example method 500 branches to an incentive search operation 510 and an access external information operation 512. At the incentive search operation 510, the incentive distribution and clearinghouse system 200 identifies and displays relevant incentives associated with an item selection as received at the item selection operation 508. For example, in some embodiments, an icon can be displayed illustrating to the customer that an incentive has been identified as associated with the identified item is displayed by the incentive distribution and clearinghouse system 200 in the user interface to notify the customer that one or more incentives are available. An example of such a user interface can be associated with the customer management module 202 of FIG. 2 and is described further below in connection with FIG. 25.

At the access external information operation 512, the incentive distribution and clearinghouse system 200 collects information from one or more third party entities relating to the products and incentives tracked by the incentive distribution and clearinghouse system 200. In general, this information collected from third party entities can take any of a number of forms. In one possible embodiment, the third party data collection module 206 is configured to collect publicly-available health and nutrition information regarding the products described by the incentives, allowing customers to view comparative health information when making a decision as to whether to accept an incentive and purchase a product. An example of such a user interface can be associated with the third party data collection module 206 of FIG. 2 and is described further below in connection with FIG. 27.

Following operations 510 and 512, operational flow of the example method 500 proceeds to a suggestions operation 514. At the suggestions operation 514, the incentive distribution and clearinghouse system 200 presents a user interface to the customer to suggest additional or competing products for the customer to buy, and for which incentives may or may not exist (e.g., depending on whether the provider of the additional product acts as an advertiser or an incentive provider). An example of such a user interface can be associated with the customer management module 202 of FIG. 2 and is described further below in connection with FIG. 25.

In some embodiments, when the customer chooses to select additional or competing products for purchase at the suggestions operation 514, process flow can return to the item selection operation 508 in which the customer can enter or select an item (e.g., grocery item) on a list (e.g., grocery list), thereby designating the item as desired for purchase. The list of items and incentives can be saved and edited by a user, for current or future use. Upon confirmation by a customer (e.g., when the customer has completed building their list and is ready to print and shop), operational flow proceeds to a print incentive/list operation 516. At the print incentive/list operation 516, the incentive distribution and clearinghouse system 200 receives a selection from the customer to consolidate and print incentives and/or a shopping list displayed on the user interface associated with the display operation 506. An example of such a printout is described further below in connection with FIG. 28.

The overall method 500 terminates at an end operation 518, which relates to completed usage of the electronic sales incentive distribution and clearinghouse system by the customer.

FIG. 6 is a flowchart of a method 600 for receipt of incentives provided by a retailer or manufacturer, according to a possible embodiment of the present disclosure. In some embodiments, the method 600 is implemented by the incentive distribution and clearinghouse system 200 described above in connection with FIG. 2. However, other embodiments are possible.

The example method 600 is instantiated at a start operation 602. The start operation 602 corresponds to initial availability of the sales incentive distribution and clearinghouse system to a retailer or manufacturer for use. Following the start operation 602, operational flow proceeds to a receive credentials operation 604. At the receive credentials operation 604, the incentive distribution and clearinghouse system 200 receives registration and/or sign-in information from a vendor (e.g., retailer, manufacturer, or other supplier). In some embodiments, a vendor enters the registration and/or sign-in information into a dedicated user interface associated with the incentive provider management module 204 of FIG. 2, above. An example of such a user interface is described below in connection with FIG. 7. However, other embodiments are possible as well.

Following receipt of sign-in information from a vendor at the receive credentials operation 604, operational flow proceeds to an association operation 606. At the association operation 606, the incentive distribution and clearinghouse system 200 correlates the vendor with an associated vendor account. Next, operation flow proceeds to a receive incentives operation 608, at which one or more incentives are received at the incentive distribution and clearinghouse system 200. For example, in some embodiments, a vendor accesses a series of user interfaces to create and/or modify incentives. In general, incentives can be created and/or modified by a manual process in which data associated with a particular incentive is entered manually into the system; alternately, incentives can be created and/or modified by an automatic process in which data associated with a particular incentive is imported or otherwise loaded (e.g., using HTTP, FTP, or any of a number of other general purpose or proprietary communications protocols) to the incentive distribution and clearinghouse system 200 from a pre-existing data file or folder. Example user interfaces accessed by a vendor to create and/or modify incentives are described below in connection with FIGS. 8-18, respectively. In general, such user interfaces may be associated with the incentive provider management module 204 of FIG. 2, as described above.

Operational flow then proceeds to a display statistics operation 610. At the display statistics operation 610, the incentive distribution and clearinghouse system 200 consolidates and presents information related to an incentive and/or an item as selected at operations 414, 416 to in a dedicated user interface to a vendor as desired.

An example of such a user interface can be associated with the administration module 208 of FIG. 2 and is described further below in connection with FIG. 19.

The overall method 600 terminates at an end operation 612, which relates to completed usage of the electronic sales incentive distribution and clearinghouse system by one or more of the vendors.

Referring back to the overall systems and methods of the present disclosure generally, it can be seen that the present disclosure provides a solution that merges customer convenience for making shopping lists with categorization to simplify a shopping experience, while concurrently managing distribution and matching of products and product incentives to those lists. The systems and methods described herein therefore provide an efficient way for customers to manage coupons and other incentives in a manner coordinated with their lists of items to be purchased; instead of multiple, unconsolidated lists of items and incentives, the present disclosure relates to a central repository for items needing to be purchased, lists and coupons/incentives. These incentives are stored until the customer is ready to use them.

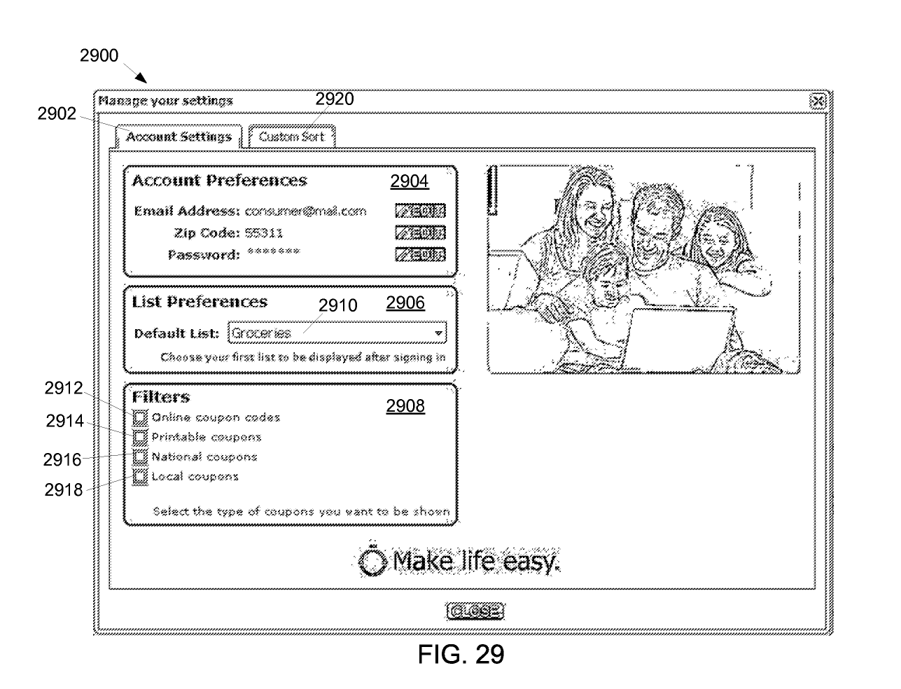

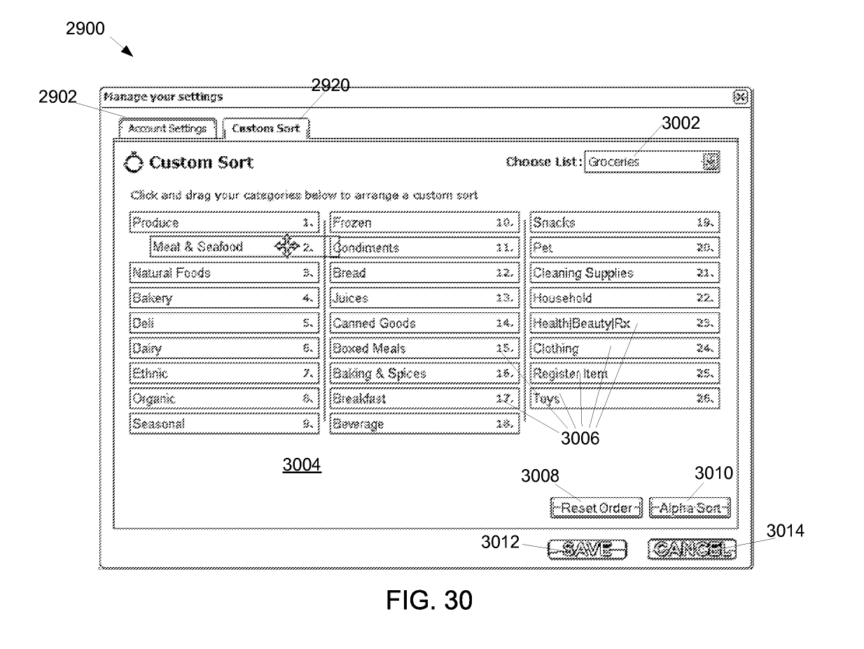

In certain embodiments, the systems and methods described herein provide mechanisms capable of sorting the customer's list or lists in a variety of ways. As further explained in connection with FIGS. 29-30, below, a customer can create specific categories associated with each list or type of lists, so that items can be associated with categories, and those categories can be manually reordered to re-sort that customer's lists. For example, a grocery list may be sortable according to categories that define products typically contained in the same aisle, and a given customer's list may sort those aisles in the order of the customer's preferred grocery store. In another example, a “To Do” list could be sorted by category of tasks, order of priority, or other arrangement created by the customer. The systems and methods described herein also provide external information to customers, manufacturers, and retailers alike, for example relating to product safety or nutrition information, product recall information, retailer issues (e.g., hours, stock, etc.) or other information relating to any of the customers, manufacturers, retailers, or products alike. It is recognized that additional advantages may also arise from the systems and methods of the present disclosure.

Referring now to FIGS. 7-30, various user interfaces are described that assist customers, vendors (e.g., manufacturers or retailers), and advertisers in exchange of information in an incentive distribution environment. In the various embodiments discussed below, FIGS. 7-18 relate generally to creation of incentives by a vendor, while FIGS. 22-30 relate generally to customer usage of the incentive distribution and clearinghouse systems described herein to develop shopping lists and obtain incentives related thereto.

Referring now to FIG. 7, an example vendor sign-in user interface 700 is shown. In some embodiments, the vendor sign-in user interface 700 is provided by the incentive provider management module 204 of the incentive distribution and clearinghouse system 200 as described above in connection with FIGS. 1-3. However, other embodiments are possible as well. In the example shown, the vendor sign-in user interface 700 includes a user-name field 702, a password field 704, a check-box 706, and a password recovery button 708.

The example user-name field 702 is configured to receive alphanumeric characters corresponding to a vendor (e.g., manufacturers, retailers, incentive provider, etc.) wishing to sign-in to the incentive distribution and clearinghouse system 200. The example password field 704 is configured to receive alphanumeric characters corresponding to a password of a vendor (e.g., manufacturers, retailers, incentive provider, etc.) wishing to sign-in to the incentive distribution and clearinghouse system 200. The example check-box 706 is configured to receive a selection to persist characters entered within the user-name field 702 and/or the password field 704. The example password recovery button 708 is configured to be selected by a vendor to initiate a password retrieval procedure. In some embodiments, the password retrieval procedure includes the incentive distribution and clearinghouse system 200 presenting of one or more identity confirmation user interfaces to the vendor. In other embodiments, the password retrieval procedure includes the incentive distribution and clearinghouse system 200 sending an identity confirmation e-mail to a known e-mail address of the subject vendor. Other embodiments of the vendor sign-in user interface 700 are possible as well.

Referring now to FIG. 8, an example incentive creation user interface 800 is shown. In some embodiments, the incentive creation user interface 800 is provided by the incentive provider management module 204 of the incentive distribution and clearinghouse system 200 as described above in connection with FIGS. 1-3. However, other embodiments are possible as well.

The example incentive creation user interface 800 includes a campaign-name field 802, a description field 804, a start-date field 806, and an end-date field 808.

The campaign-name field 802 is configured to receive alphanumeric characters corresponding to a name of a campaign associated with particular incentive or incentive package (e.g., “Winter 2011”). The description field 804 is configured to receive user-entered alphanumeric characters defining a name of a campaign given to a group of incentives, and can be descriptive of products and/or services a particular incentive or incentive package is drawn towards (e.g., “Frozen, household”). The start-date field 806 is configured to receive a calendar start date designating when a particular incentive or incentive package is intended to begin (e.g., “Jan. 1, 2011”). In some embodiments, the start-date field 806 is configured to receive alphanumeric characters corresponding to a calendar start date. In other embodiments, a start-date pop-up display 810 associated with the start-date field 806 is selected to automatically populate the start-date field 806 with alphanumeric characters corresponding to a calendar start date. Other embodiments are possible as well.

In general, the end-date field 808 is configured similar to the start date field 806. For example, the end-date field 808 is configured to receive a calendar end date designating when a particular incentive or incentive package is intended to terminate (e.g., “Mar. 1, 2011”). In some embodiments, the end-date field 808 is configured to receive alphanumeric characters corresponding to a calendar end date. In other embodiments, an end-date pop-up display 812 associated with the end-date field 808 is selected to automatically populate the end-date field 808 with alphanumeric characters corresponding to a calendar end date.

The example incentive creation user interface 800 further includes an incentive duration indicator 814, a campaign metadata indicator 816, a confirmation button 818, and a cancellation button 820. In general, the example incentive duration indicator 814 is configured to display a period of time representing a difference between a calendar start date of the start-date field 806 and a calendar end date of the end-date field 808. In the example shown, the incentive duration indicator 814 shows a “day duration” period of time. However, it will be appreciated that alternative time intervals (e.g., week, month, etc.) can be displayed by the incentive duration indicator 814 as well.

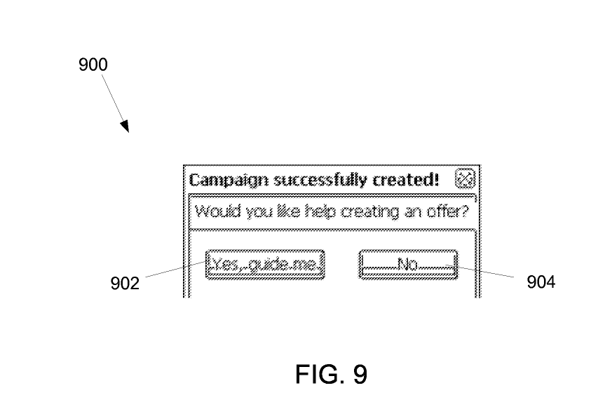

The campaign metadata indicator 816 is configured to at least display metadata corresponding to creation and modification of the particular incentive or incentive package designated within the campaign-name field 802. However, other metadata are possible as well. The confirmation button 818 is configured to receive selection from an incentive provider (i.e., selection via mouse cursor, etc.) to access further user interfaces corresponding to creation or modification of a particular incentive or incentive package, as described in further detail below in connection with FIGS. 9-18. In contrast, the cancellation button 820 is configured to receive selection from a user to terminate further creation or modification of a particular incentive or incentive package.

Other embodiments of the incentive creation user interface 800 are possible as well.

Referring now to FIG. 9, an example campaign creation confirmation user interface 900 is shown. In some embodiments, the campaign creation confirmation user interface 900 is provided by the incentive provider management module 204 of the incentive distribution and clearinghouse system 200 as described above in connection with FIGS. 1-3. However, other embodiments are possible as well.

In the example shown, the campaign creation confirmation user interface 900 includes a guidance selection button 902 and a guidance refusal button 904. The guidance selection button 902 is configured to receive selection from an incentive provider to access one or more of a series of user interfaces (not shown) for providing guidance in creating an offer or campaign of one or more offers associated with a particular incentive or incentive package. In general, an “offer” corresponds to particular incentive or incentive package for a specific product, as described in further detail below. In contrast, the guidance refusal button 904 is configured to receive selection from an incentive provider to bypass the series of user interfaces for providing guidance in creating an offer associated with particular incentive or incentive package. Other embodiments of the incentive creation confirmation user interface 900 are possible as well.

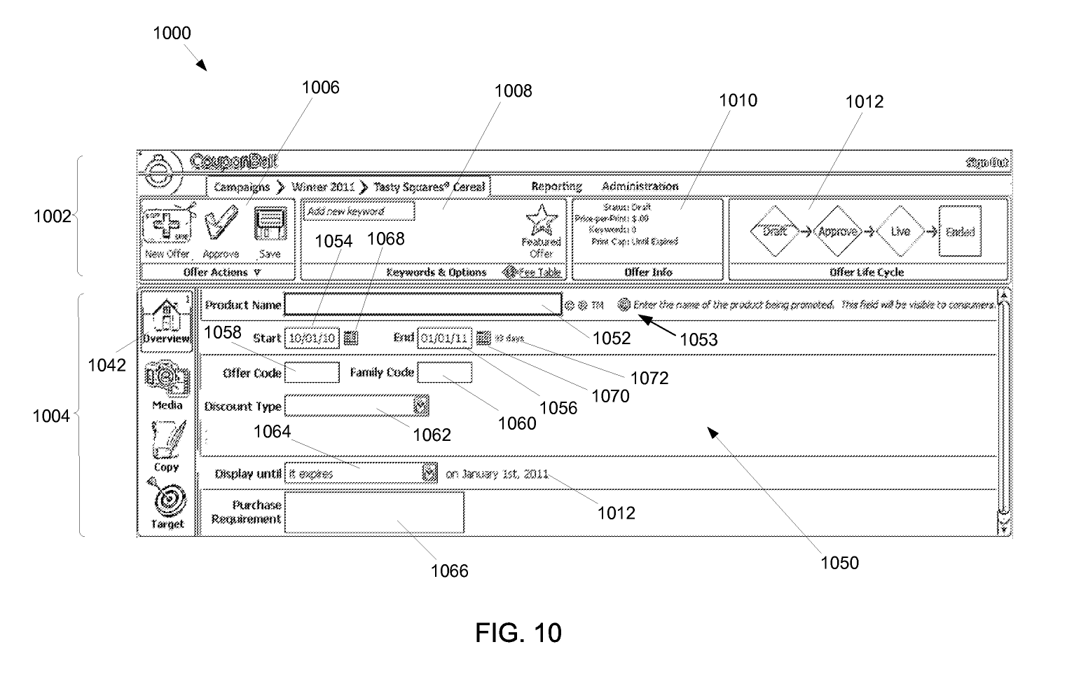

Referring now to FIGS. 10-13, a first series of campaign and incentive creation user interfaces 1000, 1100, 1200, and 1300, respectively, are shown. In some embodiments, the example user interfaces 1000, 1100, 1200, and 1300 are provided by the incentive provider management module 204 of the incentive distribution and clearinghouse system 200 as described above in connection with FIGS. 1-3 and correspond to a manual incentive creation and/or modification process such as described above in connection with FIG. 4. However, other embodiments are possible as well.

The example user interfaces 1000, 1100, 1200, and 1300 each include a first tool bar 1002 and a second tool bar 1004. The first tool bar 1002 is populated with an offer actions tool 1006, a keywords and options tool 1008, an offer info tool 1010, and an offer lifecycle tool 1012. The second tool bar 1004 includes an overview button 1042, a media button 1044, a copy button 1046, and a target button 1048. Details regarding tool bars 1002, 1004 are provided below.

Referring to the first tool bar 1002, the offer actions tool 1006 includes a new offer button 1014, an approve button 1016, and a save button 1018. The new offer button 1014 is configured to receive selection from an incentive provider to create a new offer. The approve button 1016 is configured to receive selection from the incentive provider to advance a draft of an offer associated with an incentive currently being created or modified in the respective user interfaces 1000, 1100, 1200, and 1300, to an approved stage of an offer lifecycle, as described in further detail below. The save button 1018 is configured to receive selection from the incentive provider to preserve the current state of the incentive within the offer lifecycle, so that the incentive provider can edit further at a later date. The save button 1018 can be associated with an incentive currently being created or modified in the respective user interfaces 1000, 1100, 1200, and 1300. Other embodiments of the offer actions tool 1006 are possible.

The keywords and options tool 1008 includes an add keyword field 1020, a featured offer button 1022, and a fee table link 1024. The add keyword field 1020 is configured to receive alphanumeric characters corresponding to a term or phrase (e.g., “cereal”, “breakfast”) that an incentive provider may wish to add to an offer or incentive currently being created or modified in the respective user interfaces 1000, 1100, 1200, and 1300, as described further below. The featured offer button 1022 is a toggle button allowing the incentive provider to select the currently-displayed campaign as referring to a featured offer. When selected, the featured offer button allows the incentive provider to elect to pay an additional fee to have an incentive associated with the currently-displayed campaign to be displayed to a possible customer in a customer user interface when available advertising space is available (e.g., when no other relevant offers are displayed, or when less offers are displayed than the overall area provided for incentive display in the customer user interface), as described in further detail below. Optionally, when the featured offer button 1022 is selected by the incentive provider, a pop up screen (not shown) will be presented to the incentive provider to indicate and confirm that additional fees will be charged. The fee table link 1024 is configured to display to an incentive provider an agreed-upon price-per-print corresponding to a cost associated with printing a completed offer, as negotiated with the incentive provider and as described further below. In certain embodiments, the fee table link can include a fee structure having gradually decreasing per-keyword costs based on the number of keywords included with each incentive, the number of incentives in use by the incentive provider, and any prenegotiated discounts applicable to the incentive provider. Other embodiments of the keywords and options tool 1008 are possible.

The offer info tool 1010 includes a display of a plurality of metadata corresponding to an offer or incentive currently being created or modified in the respective user interfaces 1000, 1100, 1200, and 1300. For example, in some embodiments, the offer info tool 1010 includes a Status display 1026, a Price-per-Print display 1028, a Keywords display 1030, and a Print Cap display 1032.

The Status display 1026 indicates a current state of an offer within a designated offer lifecycle, as described further below. The Price-per-Print display 1028 indicates an intended cost associated with printing a live offer. The Keywords display 1030 indicates the keywords that are currently associated with the displayed incentive (e.g., “cereal” or “breakfast” relating to a particular brand or manufacturer of cereal). The Print Cap display 1032 indicates an end-point in which a completed, live offer will no longer be displayed and may no longer be printed. Other embodiments of the offer info tool 1010 are possible, in which additional information could also be presented.

The offer lifecycle tool 1012 includes a display of a current stage within an offer lifecycle of an offer or incentive currently being created or modified in the respective user interfaces 1000, 1100, 1200, and 1300. In the example shown, offer lifecycle stages include a draft stage 1034, an approved stage 1036, a live stage 1038, and an ended stage 1040. An example offer or incentive in the draft stage 1034 corresponds to initial creation or current modification of an offer or incentive currently being created or modified in the respective user interfaces 1000, 1100, 1200, and 1300. An example offer in the approve stage 1036 corresponds to an offer or incentive that has sufficient information to make the offer live. Offers in the approve stage will be displayed to customers on the start date designated in the start-date field 1054, described below. An example offer in the live stage 1038 corresponds to an offer that has been approved and has reached its offer start date in the respective user interfaces 1000, 1100, 1200, and 1300, such that the offer is currently available for a customer to accept, print and redeem. An example offer in the ended stage 1040 corresponds to an offer or incentive that has expired (e.g., reached the end date designated in field 1056 of FIG. 10, described below), reached its print or price cap and is no longer being displayed in the respective user interfaces 1000, 1100, 1200, and 1300.

In general, more or fewer lifecycle stages may be included and/or incorporated within the offer lifecycle tool 1012 to describe a stage of an offer or incentive currently being created or modified in the respective user interfaces 1000, 1100, 1200, and 1300 as desired.

Referring now to the second tool bar 1004, each of the respective buttons of the second tool bar 1004 (i.e., overview button 1042, media button 1044, copy button 1046, and target button 1048) are configured to receive selection from an incentive provider to select from among corresponding user interfaces 1000, 1100, 1200, and 1300. For example, the overview button 1042 is configured to cause user interface 1000 to be displayed, including display region 1050; similarly, the media button 1044 causes user interface 1100 including region 1074 to be displayed. In a similar manner, the copy button 1046 is configured to receive selection from a user to access the user interface 1200, and the target button 1048 is configured to receive selection from a user to access the user interface 1300. In general, a user may freely switch between respective user interface 1000, 1100, 1200, and 1300 via selection of corresponding buttons 1042, 1044, 1046, and 1048 as desired.

Referring now specifically to the user interface 1000, which in example embodiments has been accessed via selection of the overview button 1042. The user interface 1000 generally includes a first data entry area 1050. The first data entry area 1050 includes a product-name field 1052, a start-date field 1054, an end-date field 1056, an offer code field 1058, a family code field 1060, a discount type field 1062, a display selection field 1064, and a purchase requirement field 1066.

The product-name field 1052 is configured to receive alphanumeric characters corresponding to a name of a particular product being promoted (e.g., “Tasty Squares Cereal”). Optionally, a set of additional automatic text buttons 1053 can be associated with the product-name field 1052, and can be used to generate typically-used symbols to be included in the name of a product, such as a trademark symbol as shown. Other symbols could be included in the set of automatic text buttons 1053 as well.

The start-date field 1054 is configured to receive a calendar start date designating when the particular product defined in the product-name field 1052 is intended to begin (e.g., “Oct. 1, 2010”). In some embodiments, the start-date field 1054 is configured to receive alphanumeric characters corresponding to a calendar start date. In other embodiments, a start-date pop-up display 1068 associated with the start-date field 1054 is selected to automatically populate the start-date field 1054 with alphanumeric characters corresponding to a calendar start date. Other embodiments are possible as well.

In general, the end-date field 1056 is configured similar to the start date field 1054. For example, the end-date field 1056 is configured to receive a calendar end date designating when the particular product defined in the product-name field 1052 is intended to terminate (e.g., “Jan. 1, 2011”). In some embodiments, the end-date field 1056 is configured to receive alphanumeric characters corresponding to a calendar end date. In other embodiments, an end-date pop-up display 1070 associated with the end-date field 1056 is selected to automatically populate the end-date field 1070 with alphanumeric characters corresponding to a calendar end date. In general, an incentive duration indicator 1072 is configured to display a period of time representing a difference between a calendar start date of the start-date field 1054 and a calendar end date of the end-date field 1070. In the example, the incentive duration indicator 1072 shows a “day duration” period of time. However, it will be appreciated that alternative time intervals (e.g., a week) can be displayed by the incentive duration indicator 1072 as well.

In example embodiments, the offer code field 1058 is configured to receive alphanumeric characters corresponding to a multi-digit (e.g., six digit) offer designation issued by an incentive provider. The family code field 1060 is configured to receive alphanumeric characters corresponding to multi-digit (e.g., three digits) code assigned by a manufacturer to a given couponed product or item used to validate that a consumer has purchased the couponed product. Such an example multi-digit code entered into the family code field 1060 is different from a product number used on an item, as many incentives (e.g., coupons) are useable with more than one size, color, or form of particular branded product. The discount type field 1062 is configured to receive alphanumeric characters corresponding to multi-digit code dependent on a type of discount a particular incentive provider offering. Optionally, the discount type field 1062 can be populated as a drop down or other type of selection field, in which a user could select among a variety of discount types (e.g., percentage, discount amount, or buy-x, get-x type discounts). In such embodiments, additional fields can be included to further define the parameters associated with a given discount selection (e.g., to define the percentage or dollar amounts, or to define quantities, etc.). An example of a multi-digit code entered into the discount code field 1062 include a code “05” designating “$1.40 off” of a particular item, or a code “07” designating “Buy 3 or more get $1.50 off” of a particular item, or a code “08” designating “Buy 2 or more, get $3.00 off” of a particular item, or a code “09” designating “Buy 3 or more, get $2.00 off” of a particular item, or a code “13” designating “Buy 4 or more, get $1.00 off” of a particular item. It will be appreciated that other types of discounts for a particular incentive provider offering are possible as well.

The display selection field 1064 is configured to receive alphanumeric characters designating when a particular offer should expire or stop being displayed to consumers. In some embodiments, an incentive provider can choose to have a particular offer displayed until a specific date, until consumer print counts reach a particular number, or until print fees reach a specific amount or value. The example display selection field 1064 provides an incentive provider a tool for controlling distribution of a particular coupon offer.

The purchase requirement field 1066 is configured to receive alphanumeric characters designating an item or items that must be purchased in order to use a particular coupon at checkout. An example embodiment of entry into the purchase requirement field 1066 includes “Purchase any one (1) 16 oz or larger box of Tasty Squares Brand Cereal and receive $0.50 off” However, it will be appreciated that other embodiments are possible as well.

Referring now specifically to the user interface 1100, which in example embodiments has been accessed via selection of the media button 1044. The user interface 1100 generally includes a data entry area 1074. The first data entry area 1074 includes a first media upload area 1076, a second media upload area 1078, a link definition area 1080, and an offer preview section 1082.

In example embodiments, the first media upload area 1076 includes a first media upload button 1084, a first media upload field 1086, a media type pick-list 1088, and a offer layout orientation radio button 1099. The first media upload button 1084 is configured to receive selection from a user to automatically upload a media file or folder from an electronic file system (e.g., “c-drive”). The first media upload field 1086 is configured to display a name of the media file or folder selection for upload by selection of the first media upload button 1084. The media type pick-list 1088 is configured to receive selection from a user to designate a type of media of the media file or folder selection for upload by selection of the first media upload button 1084. In general, any type of media (e.g., visual, audio) may be uploaded and designated in selection of the first media upload button 1084 and media type pick-list 1088, respectively. The offer layout orientation radio button 1099 is configured to receive selection from a user to designate a general positional orientation (i.e., “landscape or portrait”) of the incentive being arranged by the incentive provider. In the embodiment shown, the offer layout orientation button 1099 includes a portrait and landscape option, and allows the incentive provider to arrange the text and/or images included in the incentive. Optionally, one or more appearance options can be included as well, such as the reflection appearance button 1090 which alters the appearance of the graphically displayed image associated with the incentive in fields 1108, 1110.

The first media upload area 1076 additionally includes a first preview 1092 of the media as uploaded and designated, and including orientation designation, as selected with the first media upload button 1084, media type pick-list 1088, and reflection appearance button 1090, respectively. In the example embodiment, the first preview 1092 displays an image associated with the file “tasty_squares.jpg” (denoted in the first media upload field 1086 of type “image” (as noted in media type pick-list 1088) without “reflection” (designated in the reflection appearance button 1090). Other embodiments of the first media upload area 1076 are possible as well.

In example embodiments, the second media upload area 1078 includes a second media upload button 1094 and a second media upload field 1096. The second media upload button 1094 is configured to receive selection from a user to automatically upload a media file or folder from an electronic file system (e.g., “c-drive”). The second media upload field 1096 is configured to display a name of the media file or folder selection for upload by selection of the first media upload button 1084. In general, any type of media (e.g., visual, audio, etc.) may be uploaded and designated in selection of the second media upload button 1094. Following upload, one or more characteristics of the incentives can be edited within the user interfaces described herein.

The second media upload area 1078 additionally includes a second preview 1098 of the media as uploaded via selected with the second media upload button 1094. In the example embodiment, the second preview 1098 displays an image associated with the entered filename “goodness_company.jpg”. Other embodiments of the second media upload area 1078 are possible as well.

In example embodiments, the link definition area 1080 includes a media field 1102. The example media field 1102 is configured to receive alphanumeric characters corresponding to a uniform resource locator (URL) to a website relevant to a product 1104 as designated in the first media upload area 1076 and a brand/company logo as designated in the second media upload area 1078. However, other embodiments are possible as well.

Referring now to the offer preview section 1082, this section includes a basic view 1108 and a detailed view 1110 of an example offer 1112, which is based on entries within the first media upload area 1076, second media upload area 1078, and link definition area 1080, respectively.

Referring now specifically to the user interface 1200, which in example embodiments has been accessed via selection of the copy button 1046. The interface user 1200 generally includes a second data entry area 1114. The second data entry area 1114 includes a first data section 1116, a second data section 1118, and a third data section 1120.

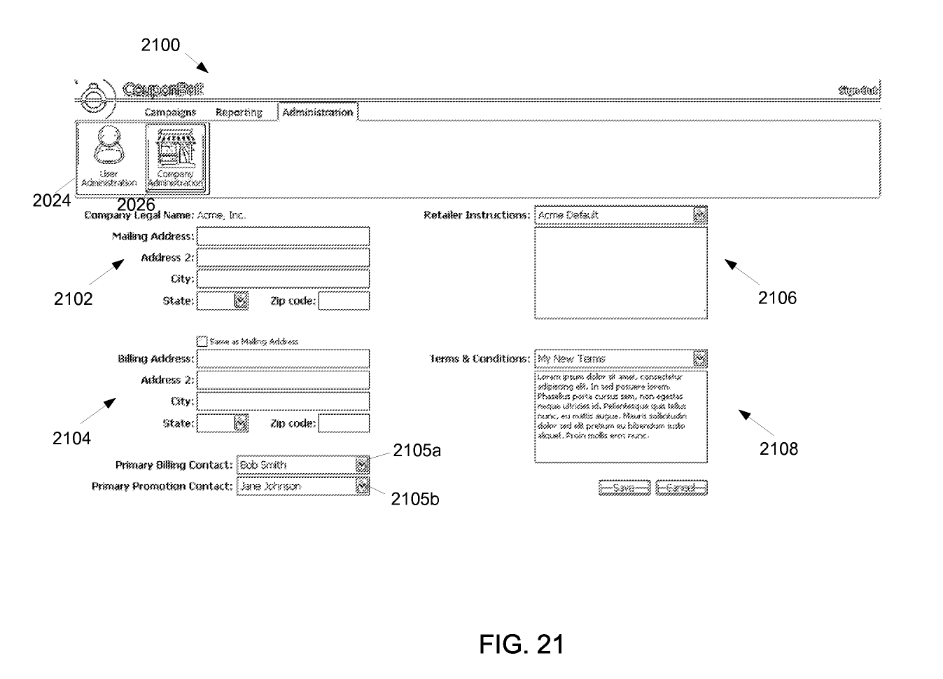

In example embodiments, the first data section 1116 is configured to describe information related to promotional information that can be displayed associated with the subject offer of interest. The second data section 1118 is configured to display a legal statement related to the subject offer of interest. In some embodiments, the legal statement in the second data entry section 1118 is manually entered. In other embodiments, a legal statement pick-list 1122, configured to be selected by an incentive provider, loads a set of terms and conditions that have been entered and saved by the incentive provider (e.g., using the administration user interface described below in connection with FIG. 21. The third data section 1120 is configured to receive alphanumeric characters corresponding to retailer instructions related to the subject offer of interest. In some embodiments, the retailer instructions are manually entered in the third data section 1120. In other embodiments, a retailer instructions pick-list 1124 allows the incentive provider to select a set of predefined Retailer Instructions (e.g., “Clearinghouse East”) into the third data section 1120. The Retailer Instructions could be edited within the data section 1120 or otherwise entered in the administrative interface illustrated in FIG. 21. Other embodiments of the user interface 1200 are possible as well.

Referring now specifically to the user interface 1300, which in example embodiments has been accessed via selection of the target button 1048, the user interface 1300 generally includes a third data entry area 1126. The third data entry area 1126 includes a geographic offer designation pick-list 1128, a geographic selectable designation 1130, and an offer delivery mode pick-list 1132.

In example embodiments, the geographic offer designation pick-list 1128 is configured to receive selection from an incentive provider to designate where the subject offer of interest should be shown such as, for example, “nationally” or “in select regions” or “in select zip codes”. Upon selection of one such option, additional fields could be displayed to further define regions of interest. For example a defined distance from the specific zip code can be added as well, by using proximity definition fields 1129. The geographic selectable designation 1130 is configured to receive selection from a user to designate “select regions” or “select zip codes” based on which one of the “in select regions” or “in select zip codes” is selected in the geographic offer designation pick-list 1128. The offer delivery mode pick-list 1132 is configured to receive selection from a user to designate a mode with which the subject offer is to be delivered such as, for example, “a Printed Coupon” or “an Online Code” or “Mobile only”. Other embodiments of the geographic offer designation pick-list 1128, geographic selectable designation 1130, and offer delivery mode pick-list 1132 are possible as well.

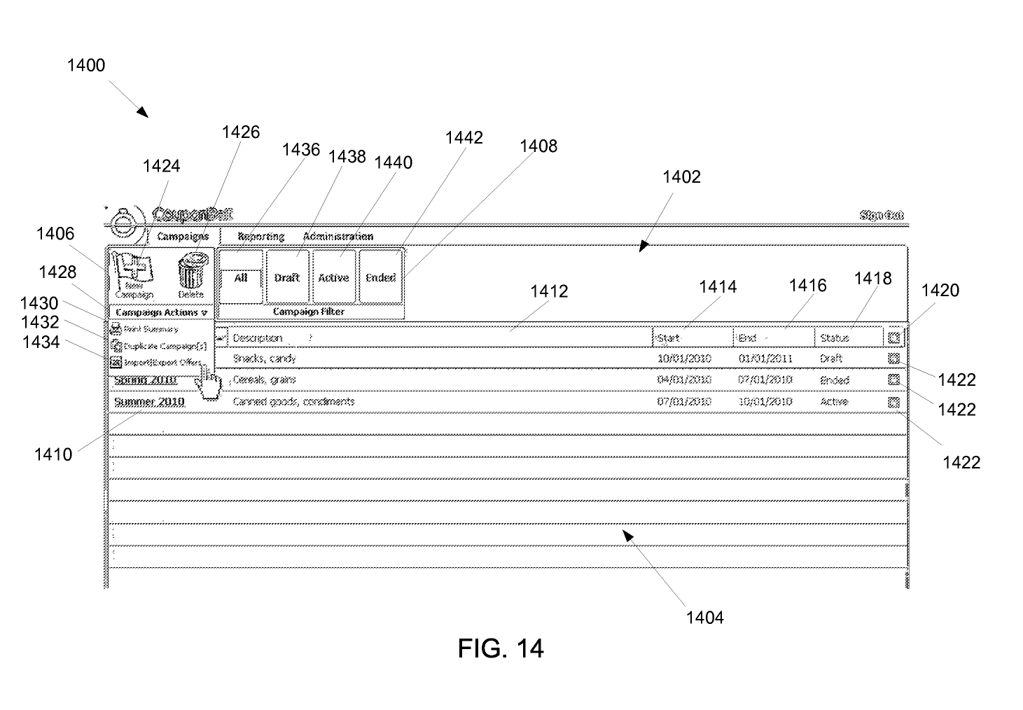

Referring now to FIGS. 14-18, a second series of incentive creation user interfaces 1400, 1500, 1600, 1700, and 1800, respectively, are shown. In some embodiments, the example user interfaces 1400, 1500, 1600, 1700, and 1800 are provided by the incentive provider management module 204 of the incentive distribution and clearinghouse system 200 as described above in connection with FIGS. 1-3. However, other embodiments are possible as well.

FIG. 14 shows a campaign management user interface 1400. In general, the user interface 1400 includes a campaign tool bar 1402 and a campaign list area 1404. The example campaign tool bar 1402 is generally populated with a campaign actions tool 1406 and a campaign filter tool 1408. The campaign list area 1404 generally includes a listing of predefined campaigns designated by a campaign name 1410, a campaign description 1412, a campaign start date 1414, a campaign end date 1416, and a campaign status 1418. The campaign list area 1404 additionally includes a check-all campaign check box 1420 configured to receive selection from a user to select all campaigns listed in the campaign list area 1404, and an individual check box 1422 associated with each of respective campaigns listed in the campaign list area 1404.

The example campaign actions tool 1406 includes a new campaign button 1424, a delete campaign button 1426, and a drop-down list 1428. The drop-down list 1428 includes a print summary action 1430, a duplicate campaign action 1432, and an import/export offer action 1434.

The new campaign button 1424 is configured to receive selection from a user to create a campaign to be a container to store and organize a particular incentive or incentives (e.g., “Summer 2010”). The delete campaign button 1426 is configured to receive selection from a user to delete one or more campaigns listed in the campaign list area 1404. In example embodiments, either the check-all campaign check box 1420 or at least one individual check box 1422 is selected followed by selection of the delete campaign button 1426 to delete a respective campaign.

The drop-down list 1428 is configured to be selected by a user to access the print summary action 1430, duplicate campaign action 1432, and import/export offer action 1434.

The print summary action 1430 is configured to receive selection from a user to print a detailed summary of one or more campaigns listed in the campaign list area 1404. In example embodiments, either the check-all campaign check box 1420 or at least one individual check box 1422 is selected followed by selection of the print summary action 1430 to print a detailed campaign summary.

The duplicate campaign action 1432 is configured to receive selection from a user to designate one or more campaigns as listed in the campaign list area 1404 as a duplicate of a different campaign. In example embodiments, either the check-all campaign check box 1420 or at least one individual check box 1422 is selected followed by selection of the duplicate campaign action 1432 to designate a given campaign to duplicate.

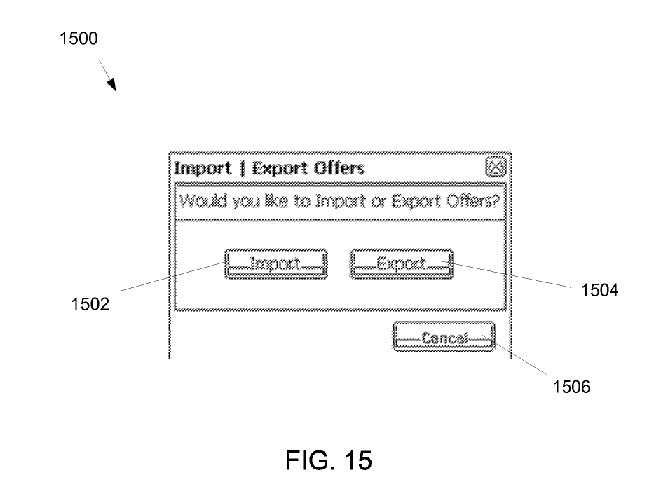

The import/export offer action 1434 is configured to receive selection from a user to import/export incentives into a campaign. For example a user of the import/export offer action could use a variety of user interfaces, such as are illustrated in FIGS. 15-18, for importing offers or campaigns for use and/or editing or exporting to a file.

Other embodiments of the campaign actions tool 1406 are possible as well.

The campaign filter tool 1408 generally includes a plurality of buttons each configured to be selected by a user to filter campaigns in the campaign list area 1404 according to associated status. For example, the campaign filter tool 1408 includes a show-all campaigns button 1436, a filter by draft status button 1438, a filter by active status button 1440, and a filter by ended status button 1442. Other embodiments of the campaign filter tool 1408 are possible as well.

Referring now to FIG. 15, an example import/export offer user interface 1500 is shown. In some embodiments, the import/export offer user interface 1500 is provided by the incentive provider management module 204 of the incentive distribution and clearinghouse system 200 as described above in connection with FIGS. 1-3. However, other embodiments are possible as well.

In example embodiments, the import/export offer user interface 1500 is accessed via selection of the import/export offer action 1434 described above in connection with FIG. 14. The import/export offer user interface 1500 includes an import offer button 1502 and an export offer button 1504. The import offer button 1502 is configured to receive selection from a user (i.e., selection via mouse cursor, etc.) to import an offer or offers into the incentive distribution and clearinghouse system 200 from a designated file or folder. In contrast, the export offer button 1504 is configured to receive selection from a user to export an offer or offers from the system to a file or folder. The import/export offer user interface 1500 additionally include a cancel import/export button 1506 configured to receive selection from a user terminate all actions associate with offer import/export. Other embodiments of the import/export offer user interface 1500 are possible as well.

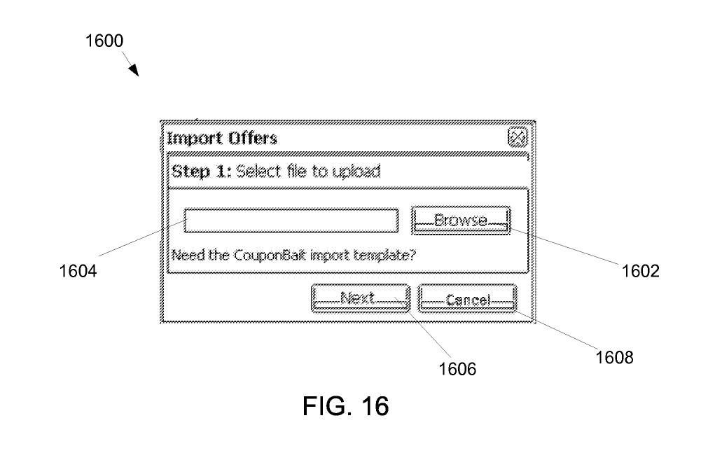

Referring now to FIG. 16, an example import file selection user interface 1600 is shown. In some embodiments, the import file selection user interface 1600 is provided by the incentive provider management module 204 of the incentive distribution and clearinghouse system 200 as described above in connection with FIGS. 1-3. However, other embodiments are possible as well.

In example embodiments, the import file selection user interface 1600 is accessed via selection of the import offer button 1502 as described above in connection with FIG. 15. In general, user interaction with the import file selection user interface 1600 corresponds to a first step in a sequence of steps for importing an offer into the incentive distribution and clearinghouse system 200.

The import file selection user interface 1600 includes a browse file button 1602, an import file field 1604, a first advancement button 1606, and a first cancel import offer button 1608. The browse file button 1602 is configured to receive selection from a user to browse an electronic file location (e.g., “c-drive”) to select a designated file or folder associated with a given offer or offers. The import file field 1604 is configured to display a file path name corresponding to the file or folder as selected via browse file button 1602. The first advancement button 1606 is configured to receive selection from a user to advance to a subsequent step in the sequence of steps for importing an offer into the incentive distribution and clearinghouse system 200. The first cancel import offer button 1608 is configured to receive selection from a user terminate all actions associate with offer import.

Other embodiments of the import file selection user interface 1600 are possible as well.

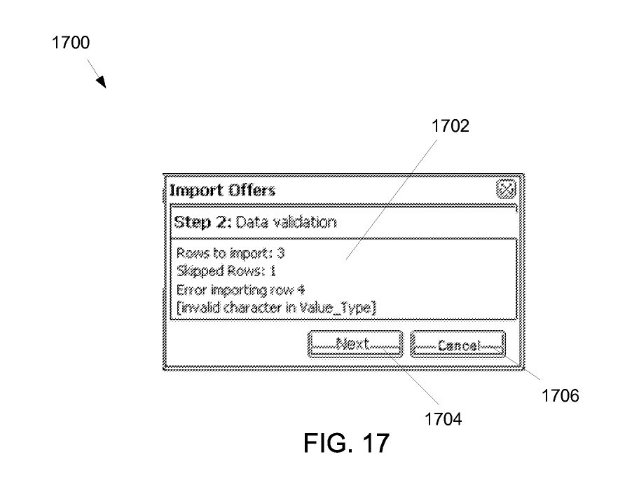

Referring now to FIG. 17, an example import validation user interface 1700 is shown. In some embodiments, the import validation user interface 1700 is provided by the incentive provider management module 204 of the incentive distribution and clearinghouse system 200 as described above in connection with FIGS. 1-3. However, other embodiments are possible as well.

In example embodiments, the import validation user interface 1700 is accessed via selection of the first advancement button 1606 as described above in connection with FIG. 16. In general, user interaction with the import validation user interface 1700 corresponds to a second step in a sequence of steps for importing an offer or offers into the incentive distribution and clearinghouse system 200.

The import validation user interface 1700 includes validation section 1702, a second advancement button 1704, and a second cancel import offer button 1706. The validation section 1702 is configured to display alphanumeric characters including data validation metadata of data contained with the file or folder specified for import in the import file field 1604, described above in connection with FIG. 16. For example, the validation section 1702 can specify number of “Rows to Import” (e.g., 3) and number “Skipped Rows” (e.g., 1). The validation section 1702 can additionally specify “Errors” (e.g., “Error importing row 4”) and associated “Error Type” (e.g., “invalid character in Value_Type). The second advancement button 1704 is configured to receive selection from a user to advance to a subsequent step in the sequence of steps for importing an offer into the incentive distribution and clearinghouse system 200. The second cancel import offer button 1706 is configured to receive selection from a user terminate all actions associate with offer import.

Other embodiments of the import validation user interface 1700 are possible as well.

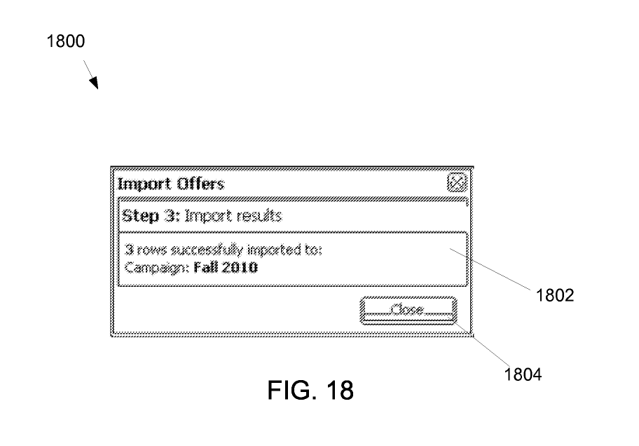

Referring now to FIG. 18, an example import results user interface 1800 is shown. In some embodiments, the import results user interface 1800 is provided by the incentive provider management module 204 of the incentive distribution and clearinghouse system 200 as described above in connection with FIGS. 1-3. However, other embodiments are possible as well.

In example embodiments, the import results user interface 1800 is accessed via selection of the second advancement button 1704 as described above in connection with FIG. 17. In general, user interaction with the import results user interface 1800 corresponds to a third step in a sequence of steps for importing an offer into the incentive distribution and clearinghouse system 200.

The import results user interface 1800 includes a summary section 1802 and a close button 1804. The summary section 1802 is configured to display alphanumeric characters including summary metadata detailing import results of data contained with the file or folder specified for import in the import file field 1604, described above in connection with FIG. 16. For example, the summary section 1802 can specify number of “Successfully Imported Rows” (e.g., 3) and associated “Campaign Name” (e.g., Fall 2010). The close button 1804 is configured to receive selection from a user to terminate the import results user interface 1800. Other embodiments of the import results user interface 1800 are possible as well.

Referring now to FIGS. 19-21, various reporting and administration user interfaces are provided for allowing an incentive provider to review results of live incentives, as well as modify user rights, contact or billing settings. FIG. 19 illustrates a reporting user interface 1900. In some embodiments, the reporting user interface 1900 is provided by the administration module 208 of the incentive distribution and clearinghouse system 200 as described above in connection with FIGS. 1-3. However, other embodiments are possible as well.

In example embodiments, the reporting user interface 1900 includes a listing of campaigns, each of which is associated with a report. The user interface 1900 can be, in certain embodiments, configured to display a reporting of a number of screen impressions, accepts, and prints of offers as well as a reporting of general usage information such as, for example, how many items are on a particular list, how many items on a particular list have coupons, how those incentives are faring versus general, averages, keyword and category trending. For example, the reporting user interface 1900 can include a plurality of campaigns 1902. In general, for each campaign 1902, a variety of reports can be generated using a charts function 1904. The reports can be of any particular type (e.g., line graph, bar graph, pictograph, pie chart, cosmograph, organizational chart, flow chart, and others) and be rendered in any particular orientation as desired. In further embodiments, the reporting user interface 1900 can include an option to download a file in any of a variety of formats (e.g., spreadsheet, comma separated file, or other text file format) including usage information for generation of further reports as desired. Other embodiments of the reporting user interface 1900 are possible as well.

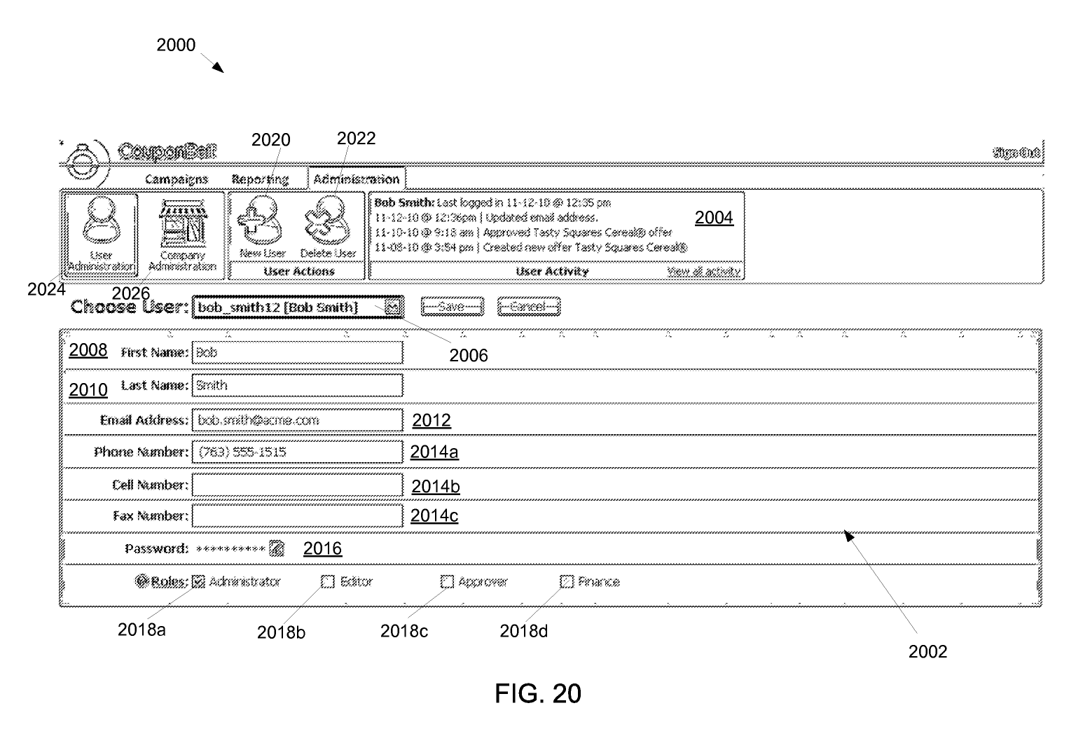

FIGS. 20-21 illustrate user interfaces provided for administration of users and company settings, for incentive providers using the incentive clearinghouse and distribution system 200 of the present disclosure. FIG. 20 illustrates a user administration interface 2000 useable by an incentive provider to edit user settings, including contact information, password information, and administrative rights for that user. The user administration interface 2000 includes a user rights editing region 2002 and a user activity field 2004. The user rights editing region 2002 includes a variety of editable fields associated with a current user, defined in a user selection drop-down box 2006. The user rights editing region 2002 includes a first name field 2008, last name field 2010, email address field 2012, and various phone number fields 2014a-c (illustrated as phone, cell phone, and fax number fields). Additionally, a password field 2016 can be included to allow the incentive provider to view/edit the password of the selected user.

In the embodiment shown, a series of roles checkboxes 2018a-d provided in the user rights editing region 2002 allow the incentive provider to select a particular predefined set of rights for the selected user. In the embodiment shown, these checkboxes relate to different set of rights, including administrative rights (checkbox 2018a, allowing full editing and administrative access), editor rights (checkbox 2018b, allowing editing rights only), approver rights (checkbox 2018c, allowing only review and approval but no editing rights), or finance rights (checkbox 2018d, relating to payment for incentive distribution). Other sets of rights and associated roles checkboxes could be included as well.

In the embodiment shown, the user activity field 2004 provides a listing of changes and activity associated with the user associated with the user selected in the drop-down box 2006. For example, in the embodiment shown the user activity field 2004 illustrates actions by a user to edit and create new incentives, as well as administrative changes to contact information. Any of a variety of other actions taken by or on behalf of that user could be tracked as well. Optionally, the user activity field 2004 can represent only a subset of the change information, with a hyperlink (shown as “View all activity”) providing a full history relating to that user.

In the embodiment shown, the user administration interface 2000 includes a new user button 2020 and a delete user button 2022, which allow the incentive provider to add or remove users from the drop down list 2006 for definition. In certain embodiments, the user administration interface 2000 can be configured to disable one or more of the buttons and options included in that user interface, for example based on the rights of the particular user logged in to the overall system (e.g., the rights of that user with respect to other users associated with the entity corresponding to the incentive provider).

FIG. 21 illustrates a company administration interface 2100 useable by an incentive provider to edit companywide settings, including contact information, billing information, retailer instructions, and terms and conditions defining the company's rights in providing incentives using the systems and methods of the present disclosure. The company administration interface 2100 includes a company mailing address editing region 2102, a billing address editing region 2104, as well as a retailer instructions region 2106 and a terms region 2108. Other regions and settings can be managed using the user interface 2100 as well.

In the embodiment shown, the company mailing address editing region 2102 and the billing address editing region 2104 allow an incentive provider to set contact information associated with correspondence and billing related to their activities using the incentive clearinghouse system 200 of the present disclosure. Optionally, additional user identification drop-down boxes 2105a-b allow the incentive provider to identify one or more particular employee to be used as a primary billing contact and a primary incentive distribution or promotion contact, respectively.

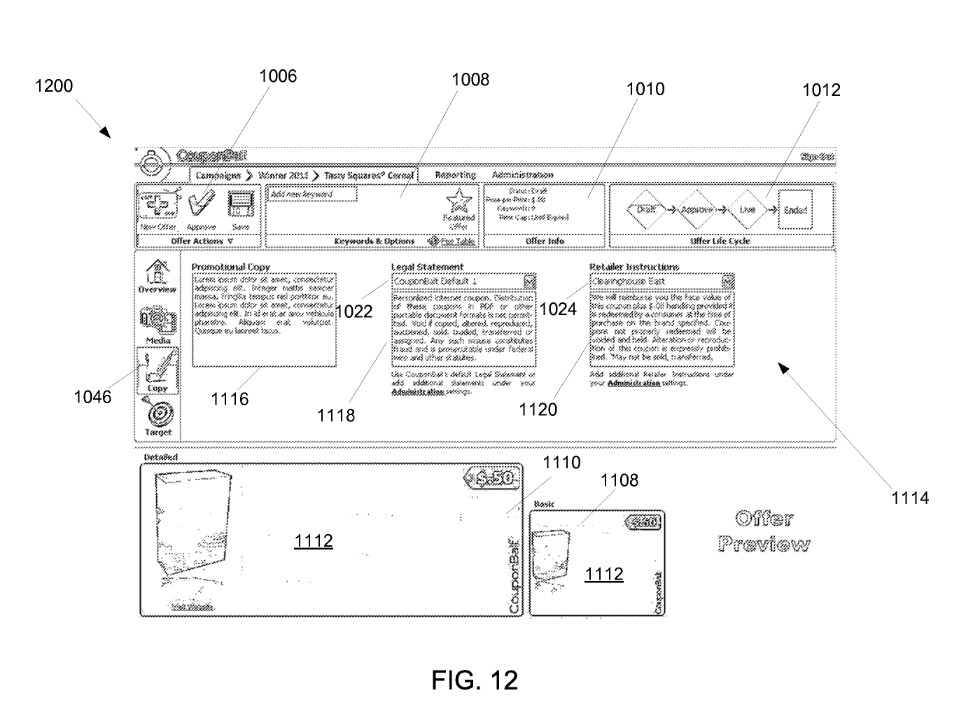

The retailer instructions region 2106 allows the incentive provider to define one or more retailer instructions, such as instructions required to obtain the benefit of an incentive. Example retailer instructions are illustrated in fields 1120 and 1124 of FIG. 12. The terms region 2108 allows the incentive provider to define a set of terms and conditions related to customer use of incentives provided by that incentive provider. An example set of terms is illustrated in FIG. 12, fields 1118 and 1122 as well.

Referring to FIGS. 20 and 21 generally, an incentive provider can access the user interfaces 2000, 2100 through an administration tab, and can toggle between the user interfaces using the user button 2024 and company administration button 2026. Other methods of navigation within the user interfaces 2000, 2100 are possible as well.

Referring now to FIGS. 22-27, a series of shopping list building interfaces 2200, 2300, and 2400 are shown. In some embodiments, user interaction with the example user interfaces 2200, 2300, and 2400 correspond to a method for building a shopping list by a customer or other user, while including available sales incentives managed by an electronic sales incentive distribution and clearinghouse system such as described above in connection with FIG. 5. However, other embodiments are possible as well.

FIG. 22 shows an example customer registration user interface 2200. In some embodiments, the customer registration user interface 2200 is provided by the customer management module 202 of the incentive distribution and clearinghouse system 200 as described above in connection with FIGS. 1-3. However, other embodiments are possible as well. In the example shown, the customer registration user interface 2200 includes a customer user-name field 2202, a customer e-mail address field 2204, a confirm e-mail address field 2206, a zip code field 2208, a customer password field 2210, and a confirm password field 2212. The customer registration user interface 2200 further includes a terms agreements checkbox 2214 and a submit registration button 2216.

The customer user-name field 2202 is configured to receive alphanumeric characters corresponding to a customer wishing to register with the incentive distribution and clearinghouse system 200. The customer e-mail address field 2204 is configured to receive alphanumeric characters corresponding to an e-mail account of the customer wishing to register with the incentive distribution and clearinghouse system 200. The confirm e-mail address field 2206 is configured to receive alphanumeric characters corresponding to the e-mail account entered in the customer e-mail address field 2204. The zip code field 2208 is configured to receive alphanumeric characters corresponding to a zip code of the customer wishing to register with the incentive distribution and clearinghouse system 200. The customer password field 2210 is configured to receive alphanumeric characters corresponding to a password of the customer wishing to register with the incentive distribution and clearinghouse system 200. The confirm password field 2212 is configured to receive alphanumeric characters corresponding to the password entered in the customer password field 2210.

The terms agreements checkbox 2214 is configured to receive a selection to confirm that the customer wishing to register with the incentive distribution and clearinghouse system 200 has agreed to terms and conditions of the incentive distribution and clearinghouse system 200. The submit button 2216 is configured to receive a selection from the customer wishing to register with the incentive distribution and clearinghouse system 200 to submit information as entered into the customer user-name field 2202, customer e-mail address field 2204, confirm e-mail address field 2206, zip code field 2208, customer password field 2210, and confirm password field 2212.

Other embodiments of the customer registration user interface 2200 are possible as well.

FIG. 23 shows an example customer registration sign-in interface 2300. In some embodiments, the customer registration sign-in interface 2300 is provided by the customer management module 202 of the incentive distribution and clearinghouse system 200 as described above in connection with FIGS. 1-3. However, other embodiments are possible as well.

In the example shown, the customer registration sign-in interface 2300 includes a customer username field 2302, a customer password field 2304, a customer check-box 2306, a customer sign-in button 2308, a customer register button 2310, and a customer password recovery button 2312.

The customer username field 2302 is configured to receive alphanumeric characters corresponding to a customer or customer wishing to sign-in to the incentive distribution and clearinghouse system 200. The customer password field 2304 is configured to receive alphanumeric characters corresponding to a password of a customer or customer wishing to sign-in to the incentive distribution and clearinghouse system 200. The customer check-box 2306 is configured to receive a selection to persist characters entered within the customer username field 2302 and/or the customer password field 2304.

The customer sign-in button 2308 is configured to receive a selection to sign-in a customer or customer (i.e., associated with the customer username field 2302 and/or the customer password field 2304) to the incentive distribution and clearinghouse system 200. The customer register button 2310 is configured to receive selection to access one or more customer registration user interfaces (i.e., customer registration user interface 2200) for a new, non-registered customer or customer.

The password recovery button 2312 is configured to be selected by a customer to initiate a password retrieval procedure. In some embodiments, the password retrieval procedure includes the incentive distribution and clearinghouse system 200 presenting of one or more identity confirmation user interfaces to the customer. In other embodiments, the password retrieval procedure includes the incentive distribution and clearinghouse system 200 sending an identity confirmation e-mail to a known e-mail address of the subject customer. Other embodiments of the vendor sign-in user interface 2300 are possible as well.

FIGS. 24-27 show an example customer item selection user interface 2400. In some embodiments, the customer item selection user interface 2400 is provided by the customer management module 202 of the incentive distribution and clearinghouse system 200 as described above in connection with FIGS. 1-3. However, other embodiments are possible as well.

In the example shown, the customer item selection user interface 2400 includes a first side bar 2402 and a second side bar 2404. The first side bar 2402 includes a lists section 2406, a categories section 2412, and a coupons section 2414. In general, each of the respective sections 2406, 2412, 2414 are configured to receive selection by a customer to collapse and expand to visually obscure and reveal corresponding information as desired. Each of these sections can include additional subsections created by a customer; for example, in the lists section, in the embodiment shown, a wish-list 2407, a groceries list 2408, and a to-do list 2410 are shown. Additional lists could be included, or could replace those shown. These lists each can include a number of items (and optionally accepted or associated incentives).

The categories section 2412 includes a number of user-definable categories, each of which can be associated with one or more item keywords, such that an item entered on a list by that customer can be associated with a category for sorting, for example using the category designation 2426, described below. In various embodiments, the one or more user-definable categories can be edited within the categories section 2412, and can be linked to keywords in a manner analogous to the association of incentives with keywords as described above. Furthermore, and as further discussed below, a set of categories could be selected and loaded by the customer based on an entered list name (for example if the list name included the name of a particular store or type of shopping), which may originate from pre-created lists of categories, or may be created as a sorting arrangement by that customer or another customer in the same geopgraphic region.

Additionally, in the embodiment shown, an alerts/info section 2416 displays third party information related to one or more items displayed in the user interface 2400, for example an item included in one of the lists in the lists section 2406. Example third-party information can include, for example, nutritional, safety, or recall information received from a monitoring entity, government institution, or other third party. Other types of third party information could be included as well.

The second side bar 2404 includes a plurality of coupon offers 2418 that are configured to receive selection by a customer who wishes to use a respective coupon offer 2418. In example embodiments, the plurality of coupon offers 2418 includes suggestion of additional or competing products for the customer to buy, and for which incentives may or may not exist (e.g., depending on whether the provider of the additional product acts as an advertiser or an incentive provider).

The customer item selection user interface 2400 additionally includes a data entry section 2420. In some embodiments, the data entry section 2420 is accessed via selection of one of the respective sections 2406-2414 of the first side bar 2402. For example, in the embodiment shown, the data entry section 2420 displays a grocery list 2422 as accessed via the lists section 2406. The grocery list 2422 optionally includes an item entry field 2421 item auto-complete drop-down list 2424 that is configured to receive entry of a desired item (e.g., “milk”) for purchase from a customer. In the embodiment shown, the automatic completion of user entry in the data entry section 2420 allows the system to correct and confirm the identity of items (e.g., due to misspellings or other textual or contextual ambiguities or errors), which assists in matching incentives to the entered products, as described herein. In certain embodiments, the automatic completion suggests one or more keywords received from an incentive provider, for example to provide a match between items to be purchased and incentives to be presented to a customer. The grocery list 2422 additionally includes a category designation 2426, a notes section 2428, and a selection checkbox 2430.

The category designation 2426 allows a user to indicate a manner in which the currently-displayed list (as selected from the group of lists included within the lists section 2406. In certain embodiments, the category designation 2426 allows a customer to select one or more pre-programmed sorting arrangements (as defined in connection with the user interface of FIG. 30, described below). For example, in the embodiment shown, the category designation 2426 includes a custom sort button 2423, which, when selected by a customer, prompts the customer to select one of a plurality of custom sorts associated with the list, for example by department in which a given item can be found, or based on types of activities (e.g., in the case of a to-do list), or other custom ordering schemes.

An item graphic 2432 (see FIG. 25) is displayed adjacent to one or more items (e.g., “milk”) entered in the item entry field 2421, depending upon the status of that item once confirmed by the system 200. In the embodiment shown, a bobber item graphic 2432 is shown, illustrating that an incentive is available associated with the item that is entered. In other embodiments, the item graphic can take other forms, depending upon the information accessible to the system 200 related to that item.

In the example embodiment, the item graphic 2432 is of a circular form, the circular shape alone may be used to determine whether at least one incentive as identified by the incentive distribution and clearinghouse system 200 is available. In such embodiments, the user can manipulate a cursor 2434 to hover over the item graphic 2432 to determine whether least one incentive as identified by the incentive distribution and clearinghouse system 200 is available. For example, in the embodiment shown in FIG. 25, placement of the cursor 2434 at or near the item graphic 2432 automatically generates a message pop-up 2436 indicating that “Related coupons found!” In certain circumstances, for example where no incentives relate to the item entered into the data entry section 2420, no item graphic is displayed alongside that item.

It will be appreciated that the item graphic 2432 can assume any form as desired to designate whether at least one incentive as identified by the incentive distribution and clearinghouse system 200 is available. Still other embodiments are possible as well, and other icon appearances can be used to denote different item statuses.

In some embodiments, the item graphic 2432 assumes a different shape upon acceptance of an incentive associated with the item. For example, in the embodiment shown in FIG. 26, the item graphic 2432 assumes “check-mark” form to designate prior acceptance of an incentive for the respective item. In the example embodiment placement of the cursor 2434 at or near the item graphic 2432 automatically generates the message pop-up 2436 indicating that “You have accepted a coupon for this item!”.

In some embodiments, the message pop-up 2436 is configured to display publicly-available health and nutrition information regarding a particular product and/or product recall or safety warning information regarding a particular product or brand, as collected by the third party data collection module 206 described above in connection with FIG. 2. For example, in the embodiment shown in FIG. 27, placement of the cursor 2434 at or near the item graphic 2432 automatically generates the coupon pop-up 2436 indicating that “Related alert found!” for item “tortillas”. In the example embodiment, the item graphic 2432 can assume a “warning” form to designate an alert is pending for the respective item.

In certain additional embodiments, when such publicly-available information is available, detailed information regarding that notification can be displayed in the alerts/info section 2416. This can indicate to a customer that they may want to consider whether or not to purchase that selected product, or whether to elect a different product for purchase due to the warning or health information displayed. Additional notifications can be included as well, such as relating to price changes or other changes or information relating to items available from publicly-available or other non-incentive information. Other embodiments of the customer item selection user interface 2400 are possible as well.

In certain embodiments, a variety of options are presented to a customer in the data entry section 2420 when associated with a list such as the grocery list 2422. For example, in the embodiment shown, a number of functions 2450 are illustrated as associated with the list, including a Blitz function 2450a, a find function 2450b, a copy function 2450c, a move function 2450d, a delete function 2450e, and a print function 2450f. The Blitz function 2450a acts to accept an incentive for each of the items associated with an incentive, as opposed to requiring user review and acceptance of an incentive. In many cases, more than one incentive may be associated with each item or keyword, so the Blitz function 2450a will operate according to a predetermined algorithm to select an incentive. Example algorithms can include random selection, first-listed selection, or some algorithm to attempt to achieve a maximum dollar amount saved. Other Blitz selection factors, such as geographical preferences or brand preference algorithms can be used as well.

The find function 2450b will allow a user to search for a particular item within the list or another list maintained by the user, or within the system 200 overall. The copy function 2450c allows a user to create a repeat entry of some other item entry in a list (or to copy an entire list), for example to quickly recreate a weekly grocery list, or other periodically-used list. A move function 2450d allows movement of items to a new or existing list, and a delete function 2450e removes an entered item or items from the list. The print function 2450f causes printing of the list and associated incentives, for example as illustrated in FIG. 28, below.

Referring to FIGS. 24-27 generally, a number of additional features can be included in the customer item selection user interface 2400 as well. For example, a customer may be provided the option to start their list entry using a pre-created list of items, such as items typically purchased in combination. Example combinations may include a holiday event shopping list (e.g., Christmas party list including cookies or cookie ingredients, etc.) or other events (e.g., a Super Bowl list, including chips, soda, etc.). The user may be provided the option to edit such pre-created lists using the customer item selection user interface 2400 prior to finalizing and printing that list, for example to add or edit items to be purchased, as well as to select specific incentives associated with those items. In certain embodiments, such pre-created lists are already associated with particular incentives, for example to allow cross-marketing of products by one or more incentive providers. However, if so desired, that customer could select a pre-created list that is not preassociated with incentives, implement the Blitz function 2450a, and print a list and a set of current associated incentives.

In certain embodiments, the customer item selection user interface 2400 also includes the capability of associating one or more files with an item or with an incentive. For example, based on a list item entered, a customer could also attach a music file associated with the item, a picture of the item, a document describing the item (e.g., contents of a package, a review, nutritional information, etc.), or other types of files.

Furthermore, although in different embodiments the particular functionality allowing a customer to enter information into the user interfaces may vary, in certain embodiments the various fields provide an “edit-in-place” arrangement in which a customer can edit items, categories, and other notes related to the item or category. This would be the case even in circumstances where pre-created lists or pre-created categories are selected by the customer for use in creating a list.

Referring now to FIG. 28, an example of a shopping list printout 2802 and an incentive printout 2804 are shown. In general, the incentive distribution and clearinghouse system 200, as described above in connection with FIGS. 1-3, is configured to provide the shopping list printout 2802 and the incentive printout 2804.

Specifically, as described above, an incentive provider can publish one or more incentives relating to items within the incentive distribution and clearinghouse system 200 via the incentive provider management module 204, and customers can build shopping lists of items to purchase using a user interface generated by the customer management module 202. The customer is presented with one or more of the incentives from a variety of incentive providers, and can review and select appropriate incentives. When the customer wishes to purchase items, for example on a shopping trip to a grocery store or other retailer, that customer can print his or her list (i.e., shopping list printout 2802) and linked group of selected incentives (i.e., incentive printout 2804) for use at the retailer. In certain embodiments, the list is printed in the order displayed in the user interfaces of FIGS. 24-27, such that the customer's sorting operations (e.g., using predefined categories as described herein) define the order in which items appear in the shopping list printout 2802. Therefore, using either the default sorting of items or a sorting according to the categories defined by the customer (e.g., store departments or other arrangements of items), the customer can shop in a preferred order through a store. Additionally, within the shopping list printout 2802, a set of icons are included alongside the list of items and optional notes describing specific list items, such that a shopping customer can readily determine whether an incentive has been selected and is associated and available for use relating to that item.

In the embodiment shown a notices section 2806 of the printed list can be configured to include any publicly-available information or other notices regarding the items included in the shopping list, and can be associated with the list 2802 and associated incentive printout 2804. In such embodiments, the set of icons included within the shopping list printout 2802 can include icons indicating that a notification exists for that item (e.g., a product recall or other alert). By reviewing the notices section 2806, the customer can determine the specific notification associated with that item.

In the embodiment shown, the shopping list printout 2802 lists additional information regarding the list as a whole, including the number of items included in the list 2802 and a total monetary amount saved based on selection of each of the incentives associated with the list. Other information can be listed as well.

In the embodiment shown, the shopping list printout 2802 and incentive printout 2804 can be printed by a single print command, and can be included on one or more printed pages. Other embodiments of the shopping list printout 2802 and incentive printout 2804 are possible as well.

FIG. 29 shows a user account settings interface 2900, according to a possible embodiment of the present disclosure. The user account settings interface 2900 is displayed in response to selection of an “account settings” tab 2902 available to a user based on clicking on a “settings” option in the user screens of FIGS. 24-27. The user account settings interface 2900 includes an account preferences region 2904, a list preferences region 2906, and a filters region 2908. Additional regions can be included as well, depending upon the particular settings and selections available to the customer in the customer-specific screens described herein.

The account preferences region 2904 includes, in the embodiment shown, contact information, location information, and security information associated with a user, shown as that user's email address, zip code, and password. Other information can be included as well. Each of the fields within the account preferences region are editable (in the embodiment shown, by selecting the “edit” option adjacent to each field), allowing the customer to edit their contact and security settings as desired.

The list preferences region 2906 includes a drop-down box 2910 allowing the customer to select a default list to be displayed when that customer logs in to view the lists that they have created. The filters region 2908 includes a number of selection check-box options describing filters by which one or more incentives may be included or excluded from those incentives presented to the user. In the embodiment shown, the check box options include an online coupon option 2912, a printable coupon option 2914, a national coupon option 2916, and a local coupon option 2918. Other types of coupon filters can be included as well.

FIG. 30 shows a user sort settings interface 3000, according to a possible embodiment of the present disclosure. The user sort settings interface 3000 allows a customer to select a list that they have created using the user interfaces described previously, and sort the items in that list by one or more criteria (e.g., departments in a store, etc.). The user sort settings interface 3000 is displayed in response to selection of a “custom sort” tab 2920 available to a user based on clicking on a “settings” option in the user screens of FIGS. 24-27.

The user sort settings interface 3000 includes a drop down list menu 3002 and an edit region 3004 in which user sort settings can be arranged. The drop down list menu 3002 displays a drop-down list of the various lists and/or types of lists available to the customer. For example, the drop down list menu 3002 could include categories of lists (e.g., “groceries” or “to-do's”), or user specific lists (e.g., “Sonny's Monday Grocery Store Shopping List” or “Vacation Shopping List”). Once that specific list is selected, one or more types of categories 3006 assigned to the items in that list are displayed in the edit region 3004 (optionally either entered by a user or obtained from a predetermined list of item categories). A user can edit names of the categories 3006, as well as drag and drop the various categories 3006 into an order in which items should be sorted, so that the customer when shopping will be able to view their created lists in an order such that commonly grouped items (e.g. items in a single department) are collected, and such that the customer can order items in an order in which those items appear in the physical store at which they are purchased (e.g., based on that customer's typical route through the store). A reset button 3008 resets the categories 3006 to a default ordering, and an alphabetical sort button 3010 arranges the categories alphabetically. A save button 3012 saves the current category arrangement, while a cancel button 3014 rejects any changes being made to the category arrangement.

In certain alternative arrangements of both the user sort settings interface 3000 and/or the customer item selection user interface 2400, a customer may be allowed to perform a multi-level (hierarchical) sort of items based upon generalized group and subgroup. For example, a customer may elect to sort his or her items into grocery and non-grocery items, and to further sort those items by subcategory (e.g., type of grocery or non-grocery item).

Optionally, the user sort settings interface can include additional functionality as well. For example, a user can elect to publish his or her list for adoption by other customers. For example, customers visiting the same store may use the same categorization due to the store layout (e.g., a grocery store with a produce section adjacent to bakery, adjacent to meat, etc.), or customers seeking items for a vacation may want to purchase items from the same selection of departments in a store. When one such customer creates a list and associates categories with that list, the customer can then apply a sorting arrangement as shown in FIG. 30, and can save that sorting arrangement alongside the specific categories and category definitions provided by the arrangement. The customer can then publish his or her custom sorting arrangement for use by others. Such published sorting arrangements could be presented to other users to view and adopt, for example users in the same zip code (or within a predetermined distance from that zip code) as the customer developing the list of categories (increasing the probability that those other customers would shop at similar stores). Other possibilities exist as well.

Referring to the customer user interfaces of FIGS. 22-30 overall, as well as the functionality related thereto, it is recognized that additional features can be included for customer data sharing to facilitate a shopping experience and to facilitate matching of incentives to products. For example, in certain embodiments, additional user interfaces could be included in which a user could report average costs of products purchased, which could be aggregated into a report of average costs for certain goods and services, broken down regionally, by store, or otherwise. Alternatively, such cost statistical analyses could be gathered from other publicly-available information either publicly available or provided from a third party (e.g., a manufacturer or distributor of the product), similarly to the health information described above.

Referring back to the overall systems and methods of the present disclosure generally, it can be seen that the present disclosure provides a solution that merges customer convenience for making shopping lists with distribution and matching of products and incentives to those lists. The systems and methods described herein therefore provide an efficient way for customers to manage coupons and other incentives in a manner coordinated with their lists of items to be purchased; instead of multiple, unconsolidated lists of items and incentives, the present disclosure relates to a central repository for items needing to be purchased, lists and coupons/incentives. These incentives are stored until the customer is ready to use them, and sorts their layout to match a preferred layout associated with a particular retailer or manufacturer.

The systems and methods described herein also provide external information to customers, manufacturers, and retailers alike, for example relating to product safety or nutrition information, product recall information, retailer issues (e.g., hours, stock, etc.) or other information relating to any of the customers, manufacturers, retailers, or products alike. It is recognized that additional advantages may also arise from the systems and methods of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. An electronic sales incentive distribution and clearinghouse system comprising:
a computing system communicatively connected to a network, the computing system including a memory configured to store incentive data, the computing system configured to:
receive an identification of one or more items from a customer;
for each of the one or more items:
compare the identification of the item to keywords associated with one or more product incentives to locate an incentive relating to the item; and
if a keyword associated with an incentive relates to the item, prompt the customer to review and accept the incentive; and
provide to the customer a shopping list of items including the item and one or more incentives including the incentive.

2. The system of claim 1, wherein the computing system is further configured to receive a plurality of incentives from one or more product suppliers.

3. The system of claim 2, wherein the one or more product suppliers includes at least one of a retailer, service provider, or a manufacturer.

4. The system of claim 1, wherein the computing system is further configured to display to the customer third party information about an item.

5. The system of claim 4, wherein the computing system is further configured to:
receive third party information relating to an item from among the one or more items.

6. The system of claim 5, wherein the third party information is selected from a group consisting of:
health information;
product recall information;
handling instructions; and
safety information.

7. The system of claim 4, wherein the item is an item included in the shopping list received from the customer.

8. The system of claim 1, wherein the computing system is further configured to:
receive price information relating to an item from among the one or more items; and
display the price information relating to the item with the shopping list.

9. The system of claim 1, wherein the computing system is further configured to, upon selection, associate at least one incentive with each item in a list of items for which an incentive is available.

10. The system of claim 1, wherein the computing system is configured to, receive an identification of one or more items from a customer by receiving from the customer selection of a predefined list of items.

11. A method of providing electronic sales incentives to a prospective customer, the method comprising:
receiving at an electronic sales incentive distribution and clearinghouse system a shopping list including one or more items;
comparing each of the items to keywords associated with one or more product incentives to locate an incentive relating to one or more of the items on the shopping list;
displaying the incentive to the customer; and
upon selection of the incentive, providing the incentive to the customer.

12. The method of claim 11, further comprising:
receiving information regarding third party information relating to an item from among the one or more items; and
displaying to the customer the third party information about the item alongside the shopping list.

13. The method of claim 12, wherein the third party information is selected from a group consisting of:
health information;
product recall information;
handling instructions; and
safety information.

14. The method of claim 11, further comprising:
receiving price information alongside the information regarding health and product safety information regarding the item; and
displaying the price information relating to the item with the shopping list.

15. The method of claim 11, further comprising sorting the shopping list into an order defined by one or more customer-defined categories.

16. The method of claim 15, further comprising printing the shopping list and associated incentives in the order defined by the one or more customer-defined categories.

17. A method of managing electronic sales incentives, the method comprising:
generating a user interface at an electronic sales incentive distribution and clearinghouse system for display to a user associated with an incentive provider;
receiving at the electronic sales incentive distribution and clearinghouse system a definition of a list of one or more incentives associated with one or more items;
receiving information regarding third party information relating to an item from among the one or more items; and
associating the third party information with the item.

18. The method of claim 17, further comprising associating the one or more incentives with data entered by a customer based at least in part on keyword information included in the definition.

19. The method of claim 17, wherein the user interface includes an offer lifecycle tool.

20. The method of claim 17, wherein the definition of one or more incentives includes information selected from the group consisting of:
a discount type;
one or more valid dates for the one or more incentives;
an offer code;
a family code;
keyword information; and
incentive amount information.

21. The method of claim 17, further comprising generating a dynamic preview of the one or more incentives.

22. The method of claim 17, wherein the definition includes region information relating to locations in which the incentive is offered.

23. The method of claim 17, wherein receiving a definition of one or more incentives includes importing incentive information using an offer import/export user interface.

24. An electronic sales incentive distribution and clearinghouse system comprising:
a computing system communicatively connected to a network, the computing system including a memory configured to store incentive data, the computing system configured to:
generate a user interface at an electronic sales incentive distribution and clearinghouse system for display to a user associated with an incentive provider;
receive at the electronic sales incentive distribution and clearinghouse system a definition of one or more incentives associated with one or more items, the definition including one or more keywords associated with the one or more incentives;
receive information regarding third party information relating to an item from among the one or more items;
associate the third party information with the item;
receive from a customer an identification of one or more items;
for each of the one or more items:
compare the identification of the item to keywords associated with one or more product incentives to locate an incentive relating to the item; and
if a keyword associated with an incentive relates to the item, prompt the customer to review and accept the incentive; and
provide to the customer a shopping list of items including the item and one or more incentives including the incentive.

25. The system of claim 24, wherein the computing system is further configured to generate a dynamic preview of the one or more incentives.

26. The system of claim 24, wherein the definition includes region information relating to locations in which the incentive is offered.

27. The system of claim 24, wherein the computing system is further configured to import incentive information using an offer import/export user interface.

28. The system of claim 24, further configured to sort the shopping list into an order defined by one or more customer-defined categories.

29. The system of claim 24, further configured to print the shopping list and associated incentives in the order defined by the one or more customer-defined categories.
